(19) United States
(12) Patent Application Publication
(10) Pub. No.: US 2011/0244218 A1
(43) Pub. Date: Oct. 6, 2011

(54) Coating composition, optical film, polarizing plate, and image display apparatus

(75) Inventors: Takato Suzuki, Kanagawa (JP); Kenichi Fukuda, Kanagawa (JP); Koji Iijima, Kanagawa (JP)

(73) Assignee: FUJIFILM Corporation, Tokyo (JP)

(21) Appl. No.: 13/064,523

(22) Filed: Mar. 30, 2011

(30) Foreign Application Priority Data
Mar. 30, 2010 (JP) P2010-079919

(51) Int. Cl. B32B 5/16; C08F 2/46; C09D 4/02

(52) U.S. Cl. 428/323; 522/182; 522/179

(57) ABSTRACT

A coating composition is provided and includes: (a) inorganic particles having an average particle size of 1 to 100 nm; (b) an ionizing radiation-curing material for forming a binder; (c) a photopolymerization initiator; and (d) an organic solvent. The coating composition preferably includes a monomer having at least two hydroxyl groups per molecule in a mass fraction of 0.1 to 3.0 mass % relative to the total solid content of the composition.

This application is based on and claims priority under 35 U.S.C. §119 from Japanese Patent Application No. 2010-79919, filed Mar. 30, 2010, the entire disclosure of which is herein incorporated by reference.

### BACKGROUND OF THE INVENTION

1. Field of the Invention

This invention relates to a coating composition providing a high-quality high-yield optical film with greatly reduced point defects that may occur in the preparation of optical films, an optical film having a layer formed of the coating composition, and a polarizing plate and an image display apparatus having the optical film.

2. Background Art

Optical films in application to image display apparatus, such as cathode ray tubes (CRTs), plasma display panels (PDPs), electroluminescence displays (ELDs), and liquid crystal displays (LCDs) are generally disposed on the surface or inside the display for the improvement of display qualities. Such optical films include an antireflection film, an antiglare film, and an optical compensation film.

Used in image display apparatus subject to direct visual observation, the optical films are strictly required to have extremely high level of freedom from point defects, such as seeds and pinholes. With the increase of the display size, the optical films are required to be free from the point defects over a larger area. Occurrence of many point defects poses a serious problem on optical film yield and productivity.

An optically functional layer of an optical film is in many cases formed by applying a solution, particularly a solution containing an organic solvent, to a transparent substrate. In such cases, characteristics of the optically functional layer, e.g., of an antireflection film, an antiglare film, or an optical compensation film are largely affected by the variation in coating film thickness. As a result, even a very small thickness variation is often distinguished as an evident point defect.

A point defect-free film and a method of making the same have therefore been desired. Known techniques therefor include dust removal from film to be coated and enhancement of cleanness of the coating step as taught in JP 2001-343505A and JP 2002-40245A and filtration of a coating liquid as proposed in JP 2000-304926A.

It is a practice in the art to add inorganic particles to a coating composition to be applied to a transparent substrate to improve the physical characteristics or functionalities such as optical characteristics of an optical film. In particular, addition of inorganic particles having an average particle size smaller than 100 nm is frequently followed as a practice which allows for improving the functionality while retaining the transparency of an optical film, as disclosed in JP 2000-112379A.

However, inorganic particles incorporated into an optical film can increase point defects, which has been a great problem in imparting functionality. To solve the problem, surface treatment of the inorganic particles with, e.g., a silane coupling agent has been proposed in JP 2000-9908A, which is still insufficient for eliminating the point defect problem.

### SUMMARY. OF THE INVENTION

An object of the invention is to provide a coating composition providing an optical film having improved functionality while retaining transparency, particularly a high-quality optical film with reduced point defects in high yield.

Another object of the invention is to provide a high-quality high-yield optical film with high transparency, high hardness, and reduced point defects which includes a layer formed of the coating composition.

Still another object of the invention is to provide a polarizing plate and an image display apparatus both having the optical film.

As a result of extensive investigation, the present inventors have found that the above objects of the invention are accomplished by the provision of the following subject matter.

(1) A coating composition comprising:
(a) inorganic particles having an average particle size of 1 to 100 nm;
(b) an ionizing radiation-curing material for forming a binder;
(c) a photopolymerization initiator; and
(d) an organic solvent.
   (2) The coating composition according to item (1), further comprising (e) a monomer having at least two hydroxyl groups per molecule in a mass fraction of 0.1 to 3.0 mass % relative to a total solid content of the composition.
   (3) The coating composition according to item (2), wherein the monomer (e) has an acryloyl group or a methacryloyl group.
   (4) The coating composition according to item (3), wherein the number of the acryloyl group or the methacryloyl group per molecule of the monomer (e) is 1.
   (5) The coating composition according to any one of items (1) to (4), wherein the ionizing radiation-curing material has an alkylene oxide moiety in a molecule thereof.
   (6) An optical film comprising a transparent substrate and a layer on the substrate, the layer being formed by coating the coating composition according to any one of items (1) to (5).
   (7) The optical film according to item (6), wherein the layer is a hardcoat layer.
   (8) The optical film according to item (6) or (7), further comprising, on the layer, a low refractive index layer.
   (9) A polarizing plate comprising a polarizer and a protective film on both sides of the polarizer, at least one of the protective films is the optical film according to any one of items (6) to (8).
   (10) An image display apparatus comprising the optical film according to any one of items (6) to (8) or a polarizing plate according to item (9).

### BRIEF DESCRIPTION OF THE DRAWING

FIG. 1 is a schematic cross-section showing an exemplified embodiment of the optical film of the invention.

FIG. 2 is a schematic cross-section showing another exemplified embodiment of the optical film of the invention.

FIG. 3 is a schematic cross-section showing still another exemplified embodiment of the optical film of the invention.

FIG. 4 is a schematic cross-section showing an exemplified embodiment of the optical film of the invention.

FIG. 5 is a schematic cross-section showing another exemplified embodiment of the optical film of the invention.

### DETAILED DESCRIPTION OF THE INVENTION

The invention can provide an optical film having improved functionality while retaining transparency, particularly a high-quality, high-yield optical film with reduced point defects.

Exemplified embodiments according to the invention are explained below. In this specification, the term “(numeral 1)-(numeral 2)” means “(numeral 1) or more and (numeral 2) or less”. Also, in this specification, the term “(meth)acrylate” means “at least one of acrylate and methacrylate”. The terms “(meth)acrylic acid, (meth)acryloyl, etc.” also are similar.

The coating composition according to the invention essentially includes the following components (a) to (d) and preferably includes the following component (e). The mass fraction (weight fraction) of component (e) relative to the total solid content is 0.1% to 3.0% by mass (by weight).

(a) Inorganic particles having an average particle size of 1 to 100 nm
(b) Ionizing radiation-curing binder-forming material
(c) Photopolymerization initiator
(d) Organic solvent
(e) Monomer having at least two hydroxyl groups per molecule

The optical film according to the invention includes a transparent substrate and a layer formed of the coating composition on the substrate.

By the addition of component (e) to the coating composition containing inorganic particles with an average particle size of 100 nm or smaller, a high-quality optical film with reduced point defects is obtained in high yield.

The optical film of the invention is used as an antireflection film, an antiglare film, an antiglare antireflection film, a diffusion film, an optical compensation film, a surface protective film, and the like. The optical film is obtained by coating a transparent substrate with the coating composition of the invention to form a functional layer exhibiting a function, such as antireflection, antiglare, light diffusion, surface hardness, and optical compensation.

The functional layer of conventional optical films often suffers point defects easy to visually recognize because even small variations in film thickness or density of the particles cause variations in optical characteristics. Since these optical films are applied to image display apparatus and are subject to direct visual observation in transmissive or reflective mode, a very high level of freedom from point defects is demanded.

Occurrence of point defects is effectively suppressed by using the coating composition of the invention in the formation of the functional layer. The effect of the invention is outstanding especially in the formation of an antireflection film, an antiglare film, an antiglare antireflection film, a diffusion film, and an optical compensation film.

As used herein, the term “point defect” refers to a coating defect having a size of 50 μm or greater, which is recognizable to ordinary human vision. The thus defined point defect is visually observed in either transmissive or reflective mode. Transmissive or reflective observation may be done under conditions simulated according to an intended application to various image displays. For example, observation may be carried out using various light sources, such as a fluorescent lamp, a tungsten lamp, and an artificial sunlight lamp, or through polarizers arranged in a crossed configuration. The recited sizes of 50 μM or greater are observable with the naked eye. For the applications described above, the number of the point defects per square meter of the optical film is preferably 0.5 or less, more preferably 0.1 or less, even more preferably 0.05 or less, and most preferably 0.01 or less.

### I. Coating Composition

Each of components of the coating composition of the invention is explained below.

### (Component (a)) Inorganic Particle

The coating composition of the invention contains inorganic particles with an average particle size of 1 to 100 nm as component (a). Component (a) serves to improve physical properties, such as hardness, and optical properties, such as reflection or diffusion properties. Useful inorganic particles include particles of oxides of at least one metal selected from silicon, zirconium, titanium, aluminum, indium, zinc, tin, and antimony. Specific examples thereof include ZrO₂, TiO₂, Al₂O₃, In₂O₃, ZnO, SnO₂, Sb₂O₃, and ITO. Also useful are BaSO₄, CaCO₃, talc, and kaolin. Preferred of them are particles of an oxide of at least one metal selected from silicon, zirconium, titanium, and tin.

The average particle size of the inorganic particles is 1 to 100 nm, preferably 10 to 80 nm, more preferably 10 to 50 nm. Addition of functionality, for example, adjusting refractive index, increasing hardness, or imparting electric conductivity is achieved without impairing transparency by the addition of the inorganic particles whose sizes fall in that range. The term “average particle size” as used herein refers to a value as calculated taking the mass of the particles as a weight. The average particle size is determined by light scattering or electron microscopy.

The inorganic particles preferably have a specific surface area of 10 to 400 m²/g, more preferably 20 to 200 m²/g, even more preferably 30 to 150 m²/g.

In compounding components (a) to (d) or (e) into the coating composition, the inorganic particles as component (a) are preferably used in the form of a dispersion in a disperse medium.

Liquids having a boiling temperature of 60° to 170° C. are preferably used as a disperse medium for dispersing the inorganic particles. Examples of suitable disperse media include water, alcohols (e.g., methanol, ethanol, isopropyl alcohol, butanol, and benzyl alcohol), ketones (e.g., acetone, methyl ethyl ketone, methyl isobutyl ketone, and cyclohexanone), esters (e.g., methyl acetate, ethyl acetate, propyl acetate, butyl acetate, methyl formate, ethyl formate, propyl formate, and butyl formate), aliphatic hydrocarbons (e.g., hexane and cyclohexane), halogenated hydrocarbons (e.g., methyl chloride, chloroform, and carbon tetrachloride), aromatic hydrocarbons (e.g., benzene, toluene, and xylene), amides (e.g., dimethylformamide, dimethylacetamide, and n-methylpyrrolidone), ethers (e.g., diethyl ether, dioxane, and tetrahydrofuran), and ether alcohols (e.g., 1-methyl-2-propanol). Among them preferred are toluene, xylene, methyl ethyl ketone, methyl isobutyl ketone, cyclohexanone, and butanol, with methyl ethyl ketone, methyl isobutyl ketone, and cyclohexanone being particularly preferred.

The dispersing of the inorganic particles may be accomplished using a dispersing machine. Suitable dispersing machines include a sand grinder mill (e.g., a bead mill with pins), a high speed impeller mill, a pebble mill, a roller mill, an attritor, and a colloid mill. A sand grinder mill and a high speed impeller mill are particularly preferred. The particles may be subjected to preliminary dispersing using, for example, a ball mill, a three roll mill, a kneader, or an extruder.

The inorganic particles are preferably rice grain-shaped, spherical, cubic, spindle-shaped, or amorphous.

The content of component (a) in the coating composition is preferably 5% to 60%, more preferably 10% to 55%, even more preferably 15% to 50%, by mass relative to the total solid content of the coating composition.

### (Inorganic Conductive Particle)

The inorganic particles as component (a) may be electrically conductive (hereinafter simply “conductive”) inorganic particles to provide a conductive optical film. The inorganic conductive particles are preferably of a metal oxide or nitride. Examples of the metal oxide or nitride include tin oxide, indium oxide, zinc oxide, and titanium nitride. Tin oxide and indium oxide are preferred. The conductive inorganic particles may contain the metal oxide or nitride as a main component and other elements. The term “main component” as used here means a component present in the particles at the highest proportion (percent by mass) of all the components making up the particles. Examples of the other elements include Ti, Zr, Sn, Sb, Cu, Fe, Mn, Pb, Cd, As, Cr, Hg, Zn, Al, Mg, Si, P, S, B, Nb, In, V, and halogen atoms. To increase conductivity of tin oxide or indium oxide, addition of at least one of Sb, P, B, Nb, In, V, and halogen atoms is preferred. Antimony-doped tin oxide (ATO), phosphorus-doped tin oxide (PTO), and tin-doped indium oxide (ITO) are particularly preferred. The Sb content in ATO is preferably 3% to 20% by mass, the P content in PTO is preferably 3% to 20% by mass, and the Sn content in ITO is preferably 5% to 20% by mass. Particularly preferred inorganic conductive particles are PTO particles.

The average particle size of the inorganic conductive particles in the coating composition is 1 to 100 nm, preferably 10 to 80 nm, more preferably 10 to 50 nm. Using the inorganic conductive particles whose particle sizes fall within the range recited provides desired conductivity or antistatic properties without impairing the transparency of the optical film.

The inorganic conductive particles preferably have a specific surface area of 10 to 400 m²/g, more preferably 20 to 200 m²/g, even more preferably 30 to 150 m²/g.

The inorganic conductive particles may be surface treated with an organic or inorganic compound. Examples of the inorganic compound for surface treatment include alumina and silica, with silica being preferred. Examples of the organic compound for surface treatment include polyols, alkanolamines, stearic acid, silane coupling agents, and titanate coupling agents, with silane coupling agents being particularly preferred. Two or more surface treatments may be carried out in combination.

The inorganic conductive particles are preferably rice grain-shaped, spherical, cubic, spindle-shaped, or amorphous.

A combination of two or more kinds of inorganic conductive particles may be used in the optical film or in a specific layer of the optical film.

The content of the inorganic conductive particles in the coating composition is preferably 20% to 60%, more preferably 25% to 55%, even more preferably 30% to 50%, by mass relative to the total solid content of the coating composition.

The inorganic conductive particles may be used as dispersed in a disperse medium to prepare the coating composition.

### (Component (e))

The coating composition of the invention preferably contains at least one monomer having at least two hydroxyl groups per molecule as component (e). Adding component (e) is effective in reducing occurrence of point defects for unclear reasons. It is assumed that the hydroxyl groups of the monomer are adsorbed onto the surface of the inorganic particles and act as a dispersing agent to suppress agglomeration of the inorganic particles thereby to reduce the occurrence of point defects.

The monomer preferably has an acryloyl group or a methacryloyl group. The monomer more preferably contains one acryloyl or methacryloyl group per molecule to be more effective in reducing the occurrence of point defects for some unclear reasons. Examples of monomers having an acryloyl or methacryloyl group and at least two hydroxyl groups per molecule include (meth)acrylate monomers. In the context of the present invention, the term “(meth)acrylate” represents acrylate and/or methacrylate. The same applies to (meth)acrylic acid and (meth)acryloyl. Examples of the (meth)acrylate monomers include phosphoric ester type (meth)acrylate, glycerol mono(meth)acrylate, epichlorohydrin-modified hexanediol di(meth)acrylate, epichlorohydrin-modified diethylene glycol di(meth)acrylate, epichlorohydrin-modified phthalic acid di(meth)acrylate, epichlorohydrin-modified propylene glycol di(meth)acrylate, neopentyl glycol diglycidyl ether di(meth)acrylate, and a compound represented by formula:

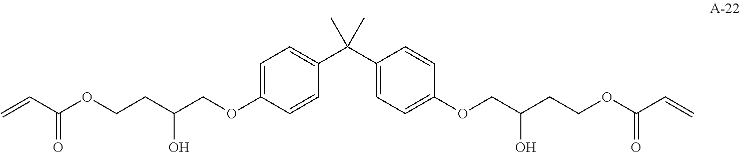

Examples of the monomer having at least two hydroxyl groups and no (meth)acryloyl groups that can be used as component (e) include bisphenol A alkylene oxide adducts, such as polyoxypropylene (2.2)-2,2-bis(4-hydroxyphenyl)propane, polyoxypropylene (3.3)-2,2-bis(4-hydroxyphenyl), polyoxypropylene (2.0)-2,2-bis(4-hydroxyphenyl), polyoxypropylene (2.0)-polyoxyethylene (2.0)-2,2-bis(4-hydroxyphenyl), polyoxypropylene (6)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, bisphenol A propylene adducts, bisphenol A ethylene adducts, hydrogenated bisphenol A; and tri- or higher polyhydric alcohols, such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Some of the monomers as component (e) are commercially available, such as Blemmer GLM from NOF Corp. and P-1M from Kyoeisha Chemical Co., Ltd., which may be used in the invention.

The monomer having at least two hydroxyl groups per molecule preferably has a mass average molecular weight less than 1000, more preferably 100 to 900, even more preferably 150 to 800. The monomer whose molecular weight falls within the recited range has a relatively high hydroxyl density and enhances the suppressing effect on the occurrence of point defects. The average molecular weight of monomers may be determined by gel permeation chromatography.

Component (e) is preferably used in an amount of 0.5% to 15%, more preferably 1% to 10%, even more preferably 1.5% to 5%, by mass relative to component (a). The mass fraction of component (e) relative to the total solid content of the coating composition is 0.1% to 3%, preferably 0.2% to 2%, more preferably 0.3% to 1%, by mass. With the mass fraction of component (e) being in that range, a coating layer with satisfactory pencil hardness is obtained while suppressing the occurrence of point defects.

### (Component (b)) Ionizing Radiation-curing Binder-forming Material

The coating composition of the invention contains an ionizing radiation-curing binder-forming material as component (b). After the coating composition is applied to a substrate to form a coating layer, the ionizing curing, binder forming material is cured to become a binder. As used herein, the term “binder” denotes a resin of which the layer formed of the coating composition of the invention is mainly composed. The phrase “a resin of which the layer is mainly composed” means a resin present in the layer in a proportion of 35% by mass or more.

The coating composition may contain a thermosetting binder-forming material as well as the ionizing curing, binder-forming material.

In the formation of a functional layer of an antireflection film, an antiglare antireflection film, a hardcoat film, an antiglare film, a surface protective film, and so on by the use of the coating composition of the invention, the functional layer is formed chiefly by the crosslinking and polymerization reaction of the ionizing radiation curing, binder forming material. That is, the binder forming material is preferably an ionizing radiation curing, polyfunctional monomer or oligomer. The functional group of the ionizing radiation curing, polyfunctional monomer or oligomer is preferably radiation-polymerizable functional group, such as a photo- (UV-) or electron beam-polymerizable functional group, particularly preferably a photopolymerizable functional group.

It is preferred to use an appropriate compound having a polymerizable unsaturated bond as the radiation-polymerizable binder forming material as described in JP 10-25388A and JP 2000-17028A. Examples of the compound having a polymerizable unsaturated bond include those having (meth)acryloyl, vinyl, styryl, allyl or a like polymerizable functional group, with those having (meth)acryloyl being preferred, and with those having two or more (meth)acryloyl groups per molecule being more preferred. In particular, when a compound having a polymerizable unsaturated group is used for a polymer body, there is produced a great combination effect in improving scratch resistance or scratch resistance after chemical treatment.

Examples of compounds having a polymerizable unsaturated bond include (meth)acrylic diesters of alkylene glycols, such as neopentyl glycol acrylate, 1,6-hexanediol (meth)acrylate, and propylene glycol di(meth)acrylate; (meth)acrylic diesters of polyoxyalkylene glycols, such as triethylene glycol di(meth)acrylate, dipropylene glycol di(meth)acrylate, polyethylene glycol di(meth)acrylate, and polypropylene glycol di(meth)acrylate; (meth)acrylic diesters of polyhydric alcohols, such as pentaerythritol di(meth)acrylate; and (meth)acrylic diesters of ethylene oxide- or propylene oxide-adducts of, e.g., 2,2-bis{4-(acryloxydiethoxy)phenyl}propane and 2,2-bis{4-(acryloxypolypropoxy)phenyl}propane.

Also preferred as a photopolymerizable polyfunctional monomer are epoxy (meth)acrylates, urethane (meth)acrylates, and polyester (meth)acrylates.

Preferred of them are esters between polyhydric alcohols and (meth)acrylic acid. More preferred are polyfunctional monomers having more than three (meth)acryloyl groups per molecule. Examples thereof are pentaglycerol pentaerythritol tetra(meth)acrylate, pentaerythritol tri(meth)acrylate, trimethylolpropane tri(meth)acrylate, ethylene oxide-modified trimethylolpropane tri(meth)acrylate, -propylene oxide-modified trimethylolpropane tri(meth)acrylate, ethylene oxide-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Examples of commercially available polyfunctional acrylate compounds having a (meth)acryloyl group for use in the invention include esters between polyols and (meth)acrylic acid, such as KAYARAD DPHA, DPHA-2C, PET-30, TMPTA, TPA-320, TPA-330, RP-1040, T-1420, D-310, DPCA-20, DPCA-30, DPCA-60, and GPO-303 (all form Nippon Kayaku Co. Ltd.) and V#3PA, V#400, V#36095D, V#1000, and V#1080 (all from Osaka Organic Chemical Industry Ltd.); tri- or higher polyfunctional urethane acrylate compounds, such as SHIKOU UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, and UV-2750B (all from Nippon Synthetic Chemical Industry Co., Ltd.), UL-503LN (from Kyoeisha Chemical), UNIDICK 17-806, 17-813, V-4030, and V-4000BA (all from DIC Corp.), EB-1290K, EB-220, EB-5129, EB-1830, and EB-4858 (all from Daicel UCB K.K.), Hi-Coap AU-2010 and AU-2020 (both from Tokushiki Co., Ltd.), Aronics M-1960 (from Toagosei Co., Ltd.), Artresin UN-3320HA, UB-3320HC, UN-3320HS, UN-904, and HDP-4T; and tri- or higher polyfunctional polyester compounds, such as Aronics M-8100, M-8030, and M-9050 (all from To a Gosei) and KRM-8307 (from Daicel-Cytec Co., Ltd.).

Resins having more than three (meth)acryloyl groups per molecule are also useful as a binder forming material, including polyester resins, polyether resins, acrylic resins, epoxy resins, urethane resins, alkyd resins, spiroacetal resins, polybutadiene resins, polythiol polyene resins, each having a relatively low molecular weight, and oligomers or prepolymers of polyfunctional compounds, such as polyhydric alcohols.

Examples of the bifunctional (meth)acrylate compounds include, but are not limited to, the following compounds.

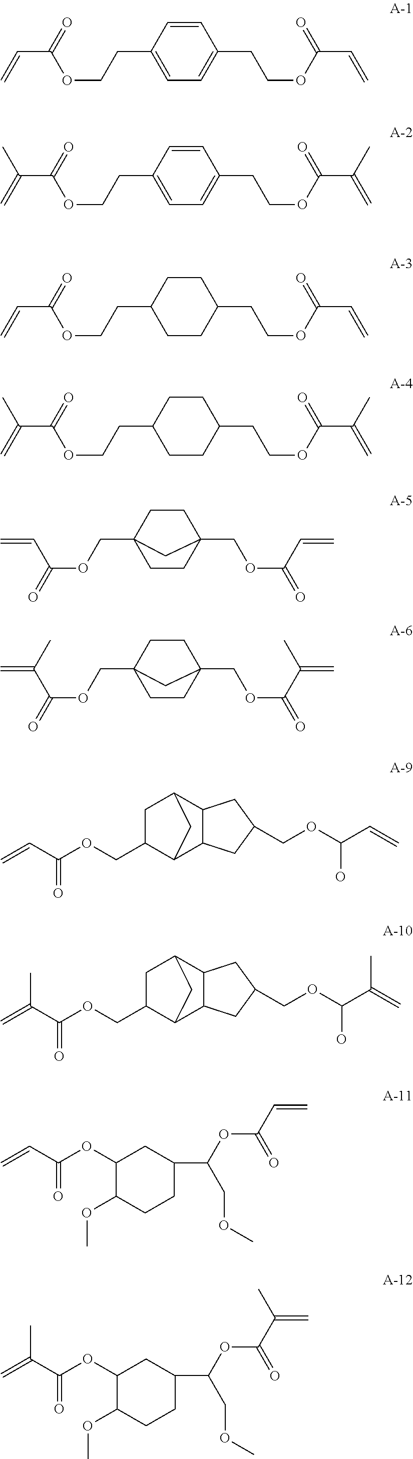

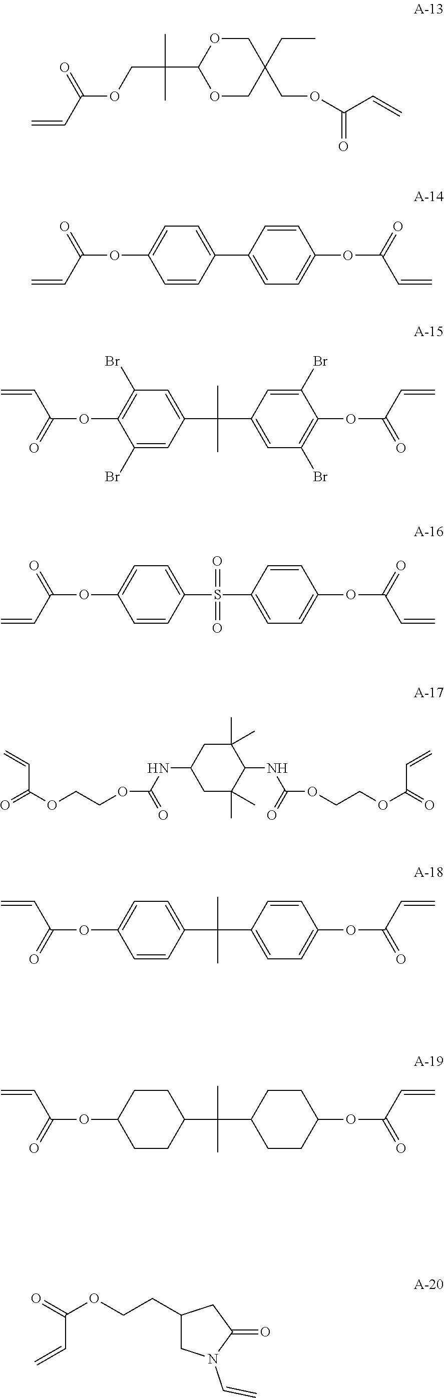

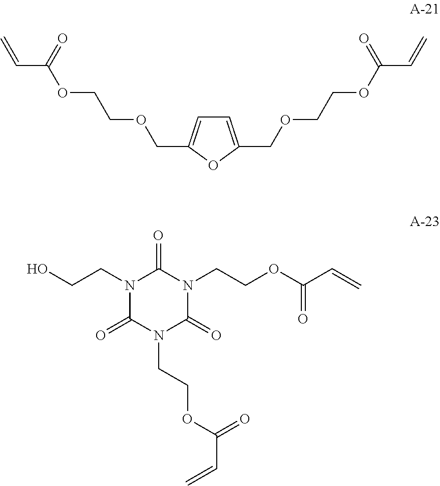

Dendrimers such as described in JP 2005-76005A and JP 2005-36105A, norbornene ring-containing monomers such as described in JP 2005-60425A, and the fluorine-containing polyfunctional (meth)acrylate compounds represented by chemical formula (2) described in JP 2002-105141A are also useful as a binder forming material.

The polyfunctional monomers described may be used either individually or in combination of two or more thereof.

Polymerization of the monomers having an ethylenically unsaturated group may be carried out by heating or irradiation with an ionizing radiation in the presence of a photo radical initiator or a thermal radical initiator.

Polymerization of the photopolymerizable polyfunctional monomer is preferably performed in the presence of a photopolymerization initiator, which is preferably a photo radical polymerization initiator or a photocation polymerization initiator, more preferably a photo radical polymerization initiator.

The ionizing radiation curing, binder forming material preferably has an alkylene oxide moiety in its molecule assumedly because the alkylene oxide moiety coordinates with the surface of the inorganic particles to improve the dispersibility of the particles.

Examples of the ionizing radiation curing, binder forming material having an alkylene oxide moiety in its molecule are listed below. In the list, n is the average number of the repeating alkylene oxide units; EO stands for ethylene oxide; and PO stands for propylene oxide.

E-1: EO adduct of trimethylolpropane tri(meth)acrylate (n=1)
E-2: EO adduct of trimethylolpropane tri(meth)acrylate (n=1.5)
E-3: EO adduct of trimethylolpropane tri(meth)acrylate (n=2)
E-4: EO adduct of trimethylolpropane tri(meth)acrylate (n=6)
E-5: PO adduct of trimethylolpropane tri(meth)acrylate (n=1)
E-6: PO adduct of trimethylolpropane tri(meth)acrylate (n=2)
E-7: EO adduct of glycerol tri(meth)acrylate (n=2)
E-8: PO adduct of glycerol tri(meth)acrylate (n=2).
E-9: EO adduct of pentaerythritol tetra(meth)acrylate (n=2)
E-10: PO adduct of pentaerythritol tetra(meth)acrylate (n=2)
E-11: EO adduct of ditrimethylolpropane tetra(meth)acrylate (n=2)
E-12: PO adduct of ditrimethylolpropane tetra(meth)acrylate (n=2)
E-13: EO adduct of dipentaerythritol penta(meth)acrylate (n=1.5)
E-14: EO adduct of dipentaerythritol hexa(meth)acrylate (n=1)
E-15: PO adduct of dipentaerythritol penta(meth)acrylate (n=1.5)
E-16: PO adduct of dipentaerythritol hexa(meth)acrylate (n=1)
E-17: tris(2-hydroxyethyl)isocyanurate tri(meth)acrylate

It is more preferred to use, as component (b), a combination of (E) a polyfunctional acrylate monomer having EO or PO added and (F) a polyfunctional acrylate monomer having no oxide added. A combined use of the polyfunctional acrylate monomers (E) and (F) provides an optical film that has high hardness and yet exhibits good adhesion and flexibility. As used herein, the phrase “acrylate monomer” denotes (meth)acrylate monomer having a (meth)acryloyl group.

The polyfunctional acrylate monomer (E), which is an EO or PO adduct, preferably contains an average of 1 to 15EO or PO units (n=1 to 15), more preferably n=1 to 10, even more preferably n=1 to 6, most preferably n=1 to 3. Examples of the polyfunctional acrylate monomer (E) include E-1 through E-17 listed above. Two or more monomers (E) may be used in combination. Of the polyfunctional acrylate monomers (E) preferred are an EO adduct of trimethylolpropane tri(meth)acrylate. Of the specific examples listed above, E-1, E-2, and E-10 are particularly preferred.

The polyfunctional acrylate monomer (F) is an ordinary polyfunctional monomer with no oxide added. Polyfunctional acrylate monomers commonly known in the art useful for the preparation of a high-hardness radiation-cured resin are preferred as the monomer (F). Examples of useful monomers (F) include, but are not limited to, the following compounds.

F-1: trimethylolpropane tri(meth)acrylate
F-2: trimethylolethane tri(meth)acrylate
F-3: pentaerythritol tetra(meth)acrylate
F-4: pentaerythritol tri(meth)acrylate
F-5: ditrimethylolpropane tetra(meth)acrylate
F-6: ditrimethylolpropane tri(meth)acrylate
F-7: dipentaerythritol hexa(meth)acrylate
F-8: dipentaerythritol penta(meth)acrylate
F-9: dipentaerythritol tetra(meth)acrylate
F-10: glycerol tri(meth)acrylate
F-11: 1,2,3-cyclohexane tetra(meth)acrylate

Two or more monomers (F) may be used in combination. Preferred of the monomers (F) listed above are F-3, F-7, and F-8. A mixture of F-7 and F-8 is also preferred.

The polyfunctional acrylate monomers (E) and (F) are preferably combined in an (E) to (F) ratio of 5:95 to 95:5, more preferably 10:90 to 90:10, even more preferably 30:70 to 70:30.

The monomers (E) and (F) are each preferably a compound providing a polymerization cured product having a high elastic modulus to assure film hardness.

The content of component (b) in the coating composition is at least 50% by mass and less than 100% by mass, preferably 55% to 98% by mass, more preferably 60% to 95% by mass, based on the total solid content of the composition.

### (Component (c)) Photopolymerization Initiator

The coating composition of the invention contains a photopolymerization initiator as component (c). Curing the ionizing radiation curing, binder forming material is carried out by irradiation with an ionizing radiation in the presence of the photopolymerization initiator. A thermal polymerization initiator may be used in combination to accelerate cure.

### <Photopolymerization Initiator>

Examples of suitable photopolymerization initiators include acetophenones, benzoins, benzophenones, phosphine oxides, ketals, anthraquinones, thioxanthones, azo compounds, peroxides (such as disclosed in JP 2001-139663A), 2,3-dialkyldione compounds, disulfide compounds, fluoroamine compounds, aromatic sulfonium compounds, lophine dimers, onium salts, borate salts, active esters, active halogen compounds, inorganic complexes, and cumarins.

Examples of the acetophenones are 2,2-dimethoxyacetophenone, 2,2-diethoxyacetophenone, p-dimethylacetophenone, 1-hydroxydimethyl phenyl ketone, 1-hydroxydimethyl p-isopropylphenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone, and 4-t-butyl-dichloroacetophenone.

Examples of the benzoins are benzoin, benzoin methyl ether, benzoin ethyl ether, benzoin isopropyl ether, benzyl dimethyl ketal, benzoin benzenesulfonate, and benzoin toluenesulfonate.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butylperoxycarbonyl)benzophenone.

Examples of the borate salts include organic boric acid salts described in Japanese Patent 2764769, JP 2002-116539A, Kunz and Martin, Rad. Tech. '98, Proceedings, Apr., pp. 19-22, 1998, Chicago, which are exemplified by the compounds described in the paragraphs [0027] of JP 2002-116539A cited supra. Other useful organic boron compounds include organic boron transition metal-coordinated complexes reported in JP 6-348011A, JP 7-128785A, JP 7-140589A, JP 7-306527A, and JP 7-292014A, which are exemplified by ion complexes with cationic dyes.

The phosphine oxides are exemplified by 2,4,6-trimethylbenzoyldiphenylphosphine oxide.

The active esters include 1,2-octanedione, 1-[4-(phenylthio)-2-(O-benzoyloxime)], sulfonic esters, and cyclic active ester compounds. Compound Nos. 1 through 21 described in JP 2000-80068A are particularly preferred.

The onium salts include aromatic diazonium salts, aromatic iodonium salts, and aromatic sulfonium salts.

The active halogen compounds include those described in Wakabayashi, et al., Bull. Chem. Soc. Japan, vol. 42, p. 2924, 1969, U.S. Pat. No. 3,905,815, JP 5-27830A, and M. P. Hutt, Journal of Heterocyclic Chemistry, vol. 1, No. 3, 1970. Oxazole compounds and s-triazole compounds substituted with a trihalomethyl group are preferred. More preferred are s-triazine derivatives having at least one mono-, di- or trihalomethyl group on the triazine nucleus. Useful active halogen compounds include 2-(p-methoxyphenyl)-4,6-bis(trichloromethyl)-s-triazine, 2-(p-styrylphenyl)-4,6-bis(trichloromethyl)-s-triazine, 2-(3-bromo-4-di(ethyl acetate)amino)phenyl)-4,6-bis(trichloromethyl)-s-triazine, and a 2-trihalomethyl-5-(p-methoxyphenyl)-1,3,4-oxadiazole. More specifically, the compounds described in JP 58-15503A (pp. 14-30), JP 55-77742A (pp. 6-10), JP 60-27673B (p. 287, compound Nos. 1 to 8), JP 60-239736A (pp. 443-444, compound Nos. 1 to 17), and U.S. Pat. No. 4,701,399 (compound Nos. 1 through 19) are particularly preferred.

The inorganic complexes are exemplified by bis(η⁵-2,4-cyclopentadien-1-yl)-bis(2,6-difluoro-3-(1H-pyrrol-1-yl)phenyl)titanium. The cumarins are exemplified by 3-ketocumarin.

The photopolymerization initiators described may be used either individually or in combination of two or more thereof.

Additional examples of useful photopolymerization initiators are described in Saishin UV Kouka Gijyutu, Technical Information Institute Co., Ltd., p. 159, 1991 and Kato Kiyomi, Shigaisenn Kouka System, Sogo Gijyutu Center, pp. 65-148, 1989.

Examples of commercially available photopolymerization initiators that are preferably used in the invention are KAYACLJRE series (e.g., DETX-S, BP-100, BDMK, CTX, BMS, 2-EAQ, ABQ, CPTX, EPD, ITX, QTX, BTC, and MCA) from Nippon Kayaku Co., Ltd.; IRGACURE series (e.g., 651, 184, 500, 819, 907, 127, 369, 1173, 1870, 2959, 4265, and 4263) from Ciba Specialty Chemicals, and Esacure series (e.g., KIP100F, KB1, EB3, BP, X33, KT046, KT37, KIP150, and TZT) from Sartomer Company. These products may be used in combination.

The content of component (c) in the coating composition is preferably 0.1 to 15 parts, more preferably 1 to 10 parts, by mass per 100 parts by mass of component (b).

### <Photo Sensitizer>

The photopolymerization initiator may be used in combination with a photo sensitizer, such as n-butylamine, triethylamine, tri-n-butylphosphine, Michler's ketone, or thioxanthone. An auxiliary photo sensitizer may be used in combination with the photo sensitizer, such as an azide compound, a thiourea compound, or a mercapto compound. Useful commercially available photo sensitizers include KAYACURE (DMBI or EPA) available from Nippon Kayaku.

### <Thermal Initiator>

The thermal radical initiators that may be used in the invention include organic or inorganic peroxides and organic azo or diazo compounds. Examples of the organic peroxides are benzoyl peroxide, halogen-substituted benzoyl peroxides, lauroyl peroxide, acetyl peroxide, dibutyl peroxide, cumene hydroperoxide, and butyl hydroperoxide. Examples of the inorganic peroxides are hydrogen peroxide, ammonium persulfate, and potassium persulfate. Examples of the azo compounds are 2,2′-azobisisobutyronitrile, 2,2′-azobispropionitrile, and 1,1′-azobiscyclohexanecarbonitrile. Examples of the diazo compounds are diazoaminobenzene and p-nitrobenzene diazonium.

### (Component (d)) Organic Solvent

The coating composition of the invention contains a solvent as component (d). The choice of the solvent is made from among various compounds in accordance with considerations, such as the ability to dissolve or disperse other components, the ability to provide a uniform coating surface in the steps of application and drying, an appropriate saturated vapor pressure, and the like. In view of drying load, it is preferred to use a combination of a solvent having a boiling temperature of 100° C. or lower at ambient temperature and pressure as a main solvent and a small amount of a solvent whose boiling temperature is higher than 100° C. for drying rate control.

Examples of the solvent whose boiling temperature is 100° C. or lower include hydrocarbons, such as hexane (boiling temperature (hereinafter the same): 68.7° C.), heptane (98.4° C.), cyclohexane (80.7° C.), and benzene (80.1° C.); halogenated hydrocarbons, such as dichloromethane (39.8° C.), chloroform (61.2° C.), carbon tetrachloride (76.8° C.), 1,2-dichloroethane (83.5° C.), and trichloroethylene (87.2° C.); esters, such as diethyl ether (34.6° C.), diisopropyl ether (68.5° C.), dipropyl ether (90.5° C.), and tetrahydrofuran (66° C.); esters, such as ethyl formate (54.2° C.), methyl acetate (57.8° C.), ethyl acetate (77.1° C.), and isopropyl acetate (89° C.); ketones, such as acetone (56.1° C.) and 2-butanone (methyl ethyl ketone) (79.6° C.); alcohols, such as methanol (64.5° C.), ethanol (78.3° C.), 2-propanol (82.4° C.), and 1-propanol (97.2° C.); cyano compounds, such as acetonitrile (81.6° C.) and propionitrile (97.4° C.); and carbon disulfide (46.2° C.), with ketones and esters being preferred, ketones being more preferred, and 2-butanone being the most preferred.

Examples of the solvents whose boiling temperature is higher than 100° C. include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (methyl isobutyl ketone) (115.9° C.), 1-butanol (117.7° C.), N,N-dimethylformamide (153° C.), N,N-dimethylacetamide (166° C.), and dimethyl sulfoxide (189° C.), with cyclohexanone and 2-methyl-4-pentanone being preferred.

The content of component (d) in the coating composition is 20% to 90%, more preferably 25% to 85%, even more preferably 30% to 80%, by mass.

### <Transparent Particles>

The coating composition of the invention may contain light-transmissive or transparent particles of various kinds. The coating composition containing transparent particles forms a functional layer to provide an optical film having antiglare properties (surface scattering properties) and internal scattering properties.

The transparent particles may be of either organic or inorganic materials. Using transparent particles with smaller size variation results in smaller variation in diffusion characteristics, making haze designing easier. Plastic beads are suitable transparent particles. In particular, plastic beads having high transparency and a certain refractive index difference from the binder as hereinafter described are preferred.

Examples of the organic transparent particles include those of polymethyl methacrylate (refractive index (hereinafter the same): 1.49), crosslinked acrylic-styrene copolymer (1.54), melamine resins (1.57), polycarbonate (1.57), polystyrene (1.60), crosslinked polystyrene (1.61), polyvinyl chloride (1.60), and benzoguanamine-melamine formaldehyde resins (1.68). Examples of the inorganic transparent particles include those of silica (1.44), alumina (1.63), zirconia, and titania. Hollow or porous inorganic transparent particles are useful.

Preferred of the transparent particles are crosslinked polystyrene particles, crosslinked poly(meth)acrylate particles, and crosslinked acrylic-styrene copolymer particles. The internal haze, surface haze, and centerline average roughness of the resulting optical film may be controlled as desired by adjusting the refractive index of the binder in accordance with the refractive index of the transparent particles selected therefrom.

A preferred combination of the transparent particles and the binder is exemplified by a combination of a binder made mainly from a tri- or higher polyfunctional (meth)acrylate monomer and having an after-cure refractive index of 1.50 to 1.53 and transparent particles of crosslinked (meth)acrylate polymer having an acrylic monomer unit content of 50% to 100% by mass, particularly of a crosslinked acrylic-styrene copolymer having a refractive index of 1.48 to 1.54.

The refractive index of the binder and that of the transparent particles both preferably range from 1.45 to 1.70, more preferably from 1.48 to 1.65. The kinds and compounding ratios of the binder and the transparent particles are chosen as appropriate so as to satisfy the above refractive index conditions. The choice may easily be determined experimentally.

The absolute difference in refractive index between the binder and the transparent particles (refractive index of transparent particles minus refractive index of binder) is preferably 0.001 to 0.030, more preferably 0.001 to 0.020, even more preferably 0.001 to 0.015. A refractive index difference greater than 0.030 can result in blur of displayed letters, reduction in display contrast in dark lightening, film cloudiness, and other problems.

The refractive index of the binder may be quantitatively evaluated by direct measurement with an Abbe refractometer or by determining the spectral reflection spectrum or by spectral ellipsometry. The refractive index of the transparent particles may be measured as follows. Mixed solvents having any two solvents having different refractive indices at varied mixing ratios to have varied refractive indices are prepared. In each of the mixed solvents are dispersed an equivalent amount of the transparent particles, and the turbidity of the dispersion is measured. The refractive index of the particles is equal to that of the mixed solvent in which the particles are dispersed with the least turbidity, as measured with an Abbe refractometer.

Because the above described transparent particles tend to settle in the binder, an inorganic filler, such as silica, may be added to the coating composition to prevent the settlement. Adding a larger amount of an inorganic filler is more effective in preventing the particles from settling out but more adversely affects the transparency of the resulting coating layer. It is advisable to add an inorganic filler having a particle size of 0.5 μm or smaller in such an amount that does not impair the transparency of the coating layer, e.g., an amount of less than 0.1% by mass relative to the binder.

The transparent particles preferably have an average particle size of 0.5 to 10 μm, more preferably 5.0 to 10.0 μm. With the particle size being within that range, the light scattering angle distribution is kept within a proper range, by which blur of displayed letters will be prevented, and the need to form a thick functional layer will be eliminated, which is advantageous to prevent curling and to reduce the cost.

Transparent particles having different average particle sizes may be used in combination. In this case, larger particles function to impart antiglare performance, while smaller particles serve to reduce the rough feel of the film surface.

The content of the transparent particles in the coating composition is preferably 3% to 30%, more preferably 5% to 20%, by mass relative to the total solid content of the composition. Within that range, the problems of letter blur, surface cloudiness, glare, and so on will be reduced.

The density of the transparent particles in the functional layer formed of the coating composition is preferably 10 to 1000 mg/m², more preferably 100 to 700 mg/m².

### <Preparation of Transparent Particle, Classification>

The transparent particles for use in the invention may be produced by any method, for example, suspension polymerization, emulsion polymerization, soapless emulsion polymerization, dispersion polymerization, or seed polymerization. For the details of the methods, reference may be made in Ohtsu Takayuki and Kinoshita Masaetsu, Kobunshi Goseino Jikkenho, Kagaku Dojin, pp. 130 and 146-147, Gosei Koubunshi, vol. 1, pp. 246-290, ibid., vol. 3, pp. 1-108, Japanese Patents 2543503, 3508304, 2746275, 3521560, and 3580320, JP 10-1561A, JP 7-2908A, JP 5-297506A, and JP 2002-145919A.

It is desirable that the transparent particles be monodisperse from the standpoint of haze and diffusion control and uniformity of the coating layer surface. Particles whose diameters are, for example, 20% or more greater than the average particle size being taken as coarse particles, it is desirable that the proportion of such coarse particles be not more than 1%, more desirably 0.1% or less, most desirably 0.01% or less, of the total number of particles. Particles having such a narrow size distribution may effectively be obtained by classifying the particles as prepared or synthesized. An increased number of times of classification and/or an increased degree of classification result in a narrower and thus more desirable size distribution. Classification is preferably carried out by air classification, centrifugation, sedimentation, filtration, electrostatic classification or a like method.

### II. Optical Film

The optical film of the invention includes a transparent substrate and a layer formed of the coating composition described above on the substrate. The layer (functional layer) formed of the coating composition of the invention may be a hardcoat layer, an antistatic layer, an antiglare layer, a low refractive index layer, an optical compensation layer, and so forth. The coating composition of the invention is especially suited to form a layer that is required to have such transparency as a haze of 1.0% or less and a pencil hardness of 2H or higher as measured under a 500 g load, such as a hardcoat layer. As used herein, the term “hardcoat layer” is intended to mean a layer having a pencil hardness of H or higher in the pencil hardness test specified in JIS K5400. The term “haze” as used for the optical film of the invention is intended to mean the haze specified in JIS K7105 (haze=(diffused light/total transmitted light)×100(%)), which is automatically measured using a hazemeter (NDH-1001DP manufactured by Nippon Denshoku Kogyo KK) in accordance with the method described in JIS K7361-1.

The coating composition is applied to a transparent substrate by any coating method, such as wire bar coating, gravure coating, or slit extrusion coating. The resulting coating layer is cured by irradiation with a radiation (e.g., UV rays or electron beam) or heat application to form a desired functional layer.

### <Layer Structure of Optical Film>

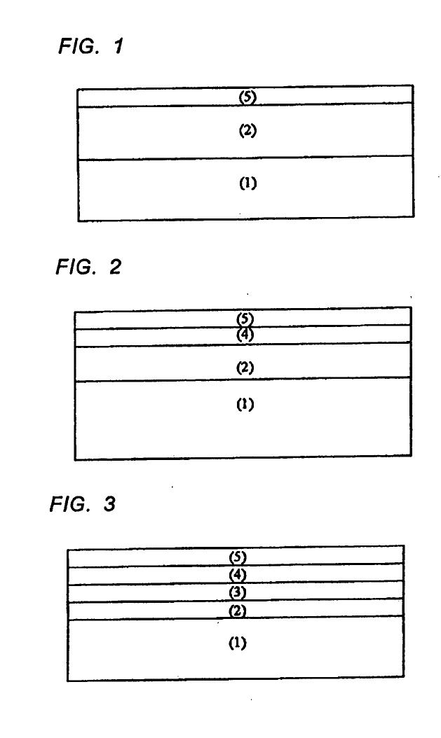

The optical film of the invention may have any known layer structure. Typical examples of the layer structure include (a) substrate/hardcoat layer, (b) substrate 1/hardcoat layer 2/low refractive index layer 5 (shown in FIG. 1), (c) substrate 1/hardcoat layer 2/high refractive index layer 4/low refractive index layer 5 (shown in FIG. 2), and (d) substrate 1/hardcoat layer 2/medium refractive index layer 3/high refractive index layer 4/low refractive index layer 5 (shown in FIG. 3).

An optical film having the layer structure (b), in which a hardcoat layer and a low refractive index layer are stacked in this order on a substrate as shown in FIG. 1, is suitable as an antireflection film. The low refractive index layer 5 may be formed on the hardcoat layer 2 with a thickness of, for example, approximately a quarter of the wavelength of incident light to reduce surface reflection.

An optical film having the layer structure (c), in which a hardcoat layer 2, a high refractive index layer 4, and a low refractive index layer 5 are stacked in this order on a substrate 1 as shown in FIG. 2, is also suited for use as an antireflection film. The reflectance of the optical film may be reduced to 1% or less by further providing a medium refractive index layer 3 between the hardcoat layer 2 and the high refractive index layer 4 as in the layer structure (d) of FIG. 3.

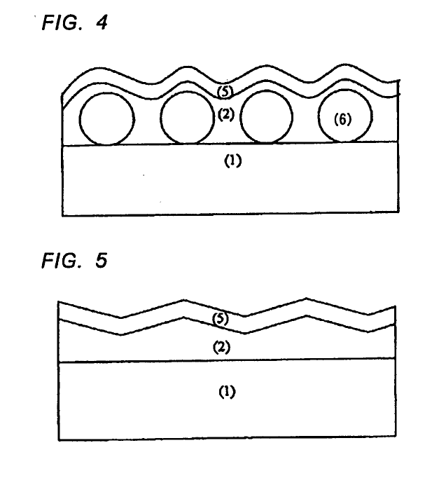

In the layer structures (a) to (d), the hardcoat layer 2 may be designed to be an antiglare layer having antiglare function. The antiglare function may be achieved by dispersing matte particles 6 in the hardcoat layer as illustrated in FIG. 4 or by surface texturing by, e.g., embossing as illustrated in FIG. 5. The antiglare layer having matte particles dispersed therein may be formed of a binder and transparent particles dispersed in the binder. It is preferred for the antiglare layer to have both antiglare function and hardcoat function. The antiglare layer may have a multilayer structure composed of, for example, two to four sublayers.

In addition to the layers discussed above, the optical film may have an additional layer between the substrate and any of the layers described or as an outermost layer on the front side thereof. Such additional layers include an interference (rainbow pattern) preventive layer, an antistatic layer (when reduction of surface resistivity on the display side is demanded, or when dust attachment to the front surface is a problem), another hardcoat layer (when one hardcoat layer or antiglare layer is insufficient for the necessary hardness), a gas barrier layer, a moisture absorbing layer (moisture barrier layer), an adhesion enhancing layer, and an antifouling (stainproof) layer.

It is preferred that the layers in the layer structures (b), (c), and (d) satisfy the refractive index relation: refractive index of hardcoat layer>refractive index of transparent substrate>refractive index of low refractive index layer.

In the case when the coating composition of the invention is used to make a multilayered antireflection film or a multilayered antiglare antireflection film, it is preferably used to form a hardcoat layer (antiglare layer), particularly a hardcoat layer with a haze of 1% or less.

### <Method for Forming Optical Film>

Each of the layers composing the optical film of the invention may be formed by any known methods, which include, but are not limited to, dip coating, air knife coating, curtain coating, roller coating, wire bar coating, gravure coating, extrusion coating (see U.S. Pat. No. 2,681,294), or microgravure coating.

The applied coating layer is preferably heat dried and then irradiated with an ionizing radiation (e.g., UV light or electron beam) to be cured.

Any ionizing radiation, including UV light, electron beam, and y-rays, may be used in the invention as long as it is capable of activating a compound to induce crosslinking cure. UV light and electron beam are preferred. UV light is particularly preferred for each of handling and of obtaining high energy. Any light source that generates UV light may be used to cause a UV-reactive compound to photopolymerize. Examples of such UV light sources include low pressure mercury lamps, middle pressure mercury lamps, high pressure mercury lamps, ultrahigh pressure mercury lamps, carbon arc lamps, metal halide lamps, and xenon lamps. Additionally, ArF excimer lasers, KrF excimer lasers, excimer lamps, or synchrotron radiation sources may also be used. While the irradiation conditions vary with the lamps, the UV radiation dosage is preferably 20 mJ/cm² or more, more preferably 50 to 10,000 mJ/cm², even more preferably 50 to 2,000 mJ/cm².

UV irradiation may be carried out each time each layer constituting the antireflection layer (medium, high, and low refractive index layers) is formed and/or after all the layers are formed. UV irradiation is preferably conducted after all the layers are formed from the productivity viewpoint.

Electron beam may be used in the same manner. An electron beam having an energy of 50 to 1000 KeV, preferably 100 to 300 KeV, which is emitted from an electron accelerator, such as a Cockroft-Walton accelerator, a Van de Graaff accelerator, a resonant transformer, an insulating-core transformer, a linear accelerator, a Dynamitron type accelerator, or a high-frequency accelerator, may be used.

In the case where each layer is formed by ionizing radiation-induced crosslinking or polymerization, the crosslinking or polymerization reaction is preferably performed in an environment having an oxygen concentration of 10% by volume or less so as to form each layer with good physical strength and chemical resistance. The oxygen concentration of the reaction environment is more preferably 6% or less, even more preferably 4% or less, still more preferably 2% or less, most preferably 1% or less, by volume.

An environment with an oxygen concentration of 10% by volume or less is preferably created by replacing the atmosphere (nitrogen concentration: ca. 79 vol %; oxygen concentration: ca. 21 vol %) with another gas, particularly nitrogen, namely, nitrogen purge.

### <Hardcoat Layer>

When the optical film of the invention is an antireflection film, it is preferred for the hardcoat layer of the antireflection film to have a haze of 1.0% or less, more preferably 0.75% or less, even more preferably 0.5% or less.

It is desirable for the antireflection film to have a smooth surface to eliminate the washout, image blur, or scintillation problem and to improve depth of black in a bright room. Specifically, it is preferred for the antireflection film to have a centerline average roughness Ra of 0.10 μm or less, more preferably 0.09 μm or less, even more preferably 0.08 μm or less. Because the surface profile of the antireflection film is predominantly governed by the surface profile of the hardcoat layer, it is preferred that the hardcoat layer have an Ra falling within the range recited.

It is necessary to control reflection characteristics as well as the surface profile. In order to eliminate the washout, image blur, or scintillation problem and to improve depth of black in a bright room, it is preferable that the ratio of the average specular reflectance at 5° to the average integrated reflectance in the wavelength region of from 450 nm to 650 nm be at least 65%, more preferably 70% or more, most preferably 75% or more.

It is also important to control the absolute value of the integrated reflectance. The average integrated reflectance in the wavelength range of from 450 nm to 650 nm is preferably 2.5% or less, more preferably 2.3% or less, even more preferably 2.0% or less.

The antireflection film preferably provides a transmitted image clarity of at least 60%. Transmitted image clarity is generally a parameter indicative of image clarity transmitted through a film. The higher the transmitted image clarity, the clearer the image transmitted through the film. The transmitted image clarity of the antireflection film is more preferably 70% or more, even more preferably 80% or more. The transmitted image clarity may be determined using an image clarity meter ICM-2D from Suga Test Instruments Co., Ltd. at an optical comb width of 0.5 mm in accordance with JIS K-7105.

The hardcoat layer of the antireflection film preferably has a reflectance of 1.45 to 2.00, more preferably 1.45 to 1.80, even more preferably 1.45 to 1.55, in view of the optical designing for obtain an antireflective film. In the case where at least one low refractive index layer is provided on the hardcoat layer, when the refractive index of the hardcoat layer is within that range, sufficient antireflection performance is secured, and tinting of reflected light is prevented.

The hardcoat layer usually has a thickness of about 0.5 to 50 μm, preferably 5 to 20 μm, more preferably 7.5 to 17.5 μm, in order to provide an optical film with sufficient durability and impact resistance. With the thickness of 5 to 20 μm, the hardcoat layer exhibits both film hardness and brittleness.

The hardcoat layer has a pencil hardness of 1H or higher, preferably 2H or higher, more preferably 3H or higher, in a pencil hardness test according to JIS K5400. Furthermore, the hardcoat layer preferably has as small Taber wear as possible in the Taber abrasion test specified in JIS K5400.

### <Low Refractive Index Layer>

When the optical film of the invention is used as an antireflection film or an antiglare antireflection film, it is preferred to provide a low refractive index layer on the functional layer, such as a hardcoat layer.

The low refractive index layer preferably has a haze of 3% or less, more preferably 2% or less, even more preferably 1% or less. The low refractive index layer preferably has a pencil hardness of H or higher, more preferably 2H or higher, even more preferably 3H or higher, in a pencil hardness test using a load of 500 g. The low refractive index layer preferably has a water contact angle of 90° or more, more preferably 95° or more, even more preferably 100° or more, to have improved antifouling properties.

The low refractive index layer is preferably formed of a binder and particles.

### <Binder>

The binder of the low refractive index layer is preferably formed from a binder forming material which is a fluorocopolymer obtained from a fluorovinyl monomer and a copolymerizable component. Examples of the fluorovinyl monomer include fluoroolefins (e.g., fluoroethylene, vinylidene fluoride, tetrafluoroethylene, and hexafluoropropylene), completely or partially fluorinated alkyl ester derivatives of (meth)acrylic acid (e.g., Viscoat 6FM from Osaka Organic Chemical Industry, Ltd. and R-2020 from Daikin Industries, Ltd.), and partially or completely fluorinated vinyl ethers. Perfluoroolefins are preferred. Hexafluoropropylene is particularly preferred for its refractive index, solubility, transparency, and availability. As the copolymerization ratio of the fluorovinyl monomer increases, the refractive index of the resulting binder becomes smaller, but the film strength decreases. From this viewpoint, the fluorovinyl monomer is preferably used to give a fluorine content of 20% to 60% by mass, more preferably 25% to 55% by mass, even more preferably 30% to 50% by mass, in the resulting copolymer.

The other copolymerizable component copolymerized together with the fluorovinyl monomer of the following (A), (B) and (C) is preferably a monomer providing crosslinkability.

Examples of such a monomer include (A) a monomer having a self-crosslinking functional group, such as glycidyl (meth)acrylate or glycidyl vinyl ether, (B) a monomer having a carboxyl group, a hydroxyl group, an amino group, a sulfo group, etc., such as (meth)acrylic acid, methylol (meth)acrylate, hydroxyalkyl (meth)acrylate, allyl acrylate, hydroxyethyl vinyl ether, hydroxybutyl vinyl ether, maleic acid, or crotonic acid, and (C) a monomer having a group reactive with the functional group possessed by the monomer (A) or (B) and another crosslinking functional group, such as a monomer obtained by causing acrylic acid chloride to react on a hydroxyl group.

The crosslinking functional group of the monomer (C) is preferably a photopolymerizable group. Examples of the photopolymerizable group include a (meth)acryloyl group, an alkenyl group, a cinnamoyl group, a cinnamylideneacetyl group, a benzalacetophenone group, a styrylpyridine group, an α-phenylmaleimide, a phenylazide group, a sulfonylazide group, a carbonylazide group, a diazo group, an o-quionediazide group, a furylacryloyl group, a cumarin group, a pyrone group, an anthracene group, a benzophenone group, a stilbene group, a dithiocarbamate group, a xanthate group, a 1,2,3-thiadiazole group, a cyclopropene group, and an azadioxabicyclo group. The monomer (C) may have more than one of these polymerizable groups. Preferred of them are (meth)acryloyl and cinnamoyl, with (meth)acryloyl being particularly preferred.

Methods for preparing a photopolymerizable group-containing fluorocopolymer include, but are not limited to, (a) esterification of a hydroxyl-containing, crosslinking functional group-containing copolymer with (meth)acrylic acid chloride, (b) urethane formation by the reaction between a hydroxyl-containing, crosslinking functional group-containing copolymer and a (meth)acrylic ester containing an isocyanate group, (c) esterification of an epoxy-containing, crosslinking functional group-containing copolymer with (meth)acrylic acid, and (d) esterification of a carboxyl-containing, crosslinking functional group-containing copolymer with a (meth)acrylic ester containing an epoxy group.

The amount of the photopolymerizable group may be selected appropriately. It is a preferred embodiment that a certain amount of a carboxyl group or a hydroxyl group remains unreacted in view of surface stability of the coating, reduction of surface defects in the presence of inorganic particles, and improvement of film strength.

The fluorocopolymer may further comprise, in addition to the repeating unit derived from the fluorovinyl monomer and the repeating unit having a (meth)acryloyl group in its side chain, a repeating unit derived from another vinyl monomer to enhance adhesion to a substrate, to control the glass transition temperature, which contributes to the film hardness, and to improve solvent solubility, transparency, slip properties, and dust- and stain-proof properties. Examples of such vinyl monomers include, but are not limited to, olefins (e.g., ethylene, propylene, isoprene, vinyl chloride and vinylidene chloride), acrylic esters (e.g., methyl acrylate, ethyl acrylate, 2-ethylhexyl acrylate, and 2-hydroxyethyl acrylate), methacrylic esters (e.g., methyl methacrylate, ethyl methacrylate, butyl methacrylate, and 2-hydroxyethyl methacrylate), styrene derivatives (e.g., styrene, p-hydroxymethylstyrene, and p-methoxystyrene), vinyl ethers (e.g., methyl vinyl ether, ethyl vinyl ether, cyclohexyl vinyl ether, hydroxyethyl vinyl ether, and hydroxybutyl vinyl ether), vinyl esters (e.g., vinyl acetate, vinyl propionate, and vinyl cinnamate), unsaturated carboxylic acids (e.g., acrylic acid, methacrylic acid, crotonic acid, maleic acid, and itaconic acid), acrylamides (e.g., N,N-dimethylacrylamide, N-t-butylacrylamide, and N-cyclohexylacryl amide), methacrylamides (e.g., N,N-dimethylmethacrylamide), and acrylonitrile derivatives. Two or more of these vinyl monomers may be used in combination. The total proportion of the units derived from these additional vinyl monomers in the fluorocopolymer is preferably 0 to 65 mol %, more preferably up to 40 mol %, even more preferably up to 30 mol %.

Of the fluorocopolymers described, particularly useful are random copolymers obtained from a perfluoroolefin and a vinyl ether or ester, especially those having a self-crosslinking group, such as a radical reactive group (e.g., (meth)acryloyl) or a ring-opening polymerizable group (e.g., epoxy or oxetanyl). The proportion of the repeating unit containing such a self-crosslinking group in the total copolymer units is preferably 5 to 70 mol %, more preferably 30 to 60 mol %. Examples of preferred copolymers are described in JP 2002-243907A, JP 2002-372601A, JP 2003-26732A, JP 2003-222702A, JP 2003-294911A, JP 2003-329804A, JP 2004-4444A, and JP 2004-45462A.

The fluorocopolymer preferably has a polysiloxane structure introduced for the purpose of imparting antifouling properties. While a polysiloxane structure may be introduced by any method, preferred methods include introducing a polysiloxane block copolymer component using a silicone macroazo initiator as taught in JP 6-93100A, JP 11-189621A, JP 11-2228631A, and JP 2000-313709A, br introducing a polysiloxane graft copolymer component using a silicone macromer as described in JP 2-251555A and JP 2-308806A. Examples of particularly preferred polysiloxane-containing fluorocopolymers are those obtained in Examples 1 to 3 of JP 11-189621A and copolymers A-2 and A-3 prepared in JP 2-251555A. The proportion of the polysiloxane component in the polysiloxane-containing fluorocopolymer is preferably 0.5% to 10%, more preferably 1% to 5%, by mass.

The fluorocopolymer that is preferably used in the invention preferably has a mass average molecular weight of more than 5,000, more preferably 10,000 to 500,000, even more preferably 15,000 to 200,000. A combined use of fluorocopolymers having different average molecular weights may results in improvement of surface conditions and scratch resistance of the coating layer.

<Compound having a Polymerizable Unsaturated Bond>

The binder forming material used to make the low refractive index layer may be a combination of the fluorocopolymer described above and a compound having a polymerizable unsaturated bond as proposed in JP 10-25388A and JP 2000-17028A or a fluorine-containing polyfunctional compound having polymerizable unsaturated bonds as proposed in JP 2002-145952. Examples of the compounds having a polymerizable unsaturated bond include those having a polymerizable functional group, such as (meth)acryloyl, vinyl, styryl, or allyl, particularly (meth)acryloyl. Particularly preferred are compounds having two or more (meth)acryloyl groups per molecule, examples of which are given below. When the fluorocopolymer is combined with the above described polymerizable polyfunctional compound, particularly a compound providing a polymerizable unsaturated group-containing polymer, there is produced a great effect in improving scratch resistance or scratch resistance after chemical treatment.

Examples of the compound having a polymerizable unsaturated bond include those described as the ionizing radiation curing, binder forming material.

The polyfunctional monomers may be used either individually or in combination of two or more thereof.

The monomer having an ethylenically unsaturated group is polymerized by irradiation with ionizing radiation or heating in the presence of a photo radical initiator or a thermal radical initiator. Polymerization of the photopolymerizable polyfunctional monomer is preferably effected using a photopolymerization initiator. The photopolymerization initiator is preferably a photo radical polymerization initiator or a photo cation polymerization initiator, with a photo radical polymerization initiator being more preferred.

### <Fluorine-Containing Polymerizable Compound>

Also preferably useful as a binder forming material is a fluorine-containing polyfunctional compound having three or more polymerizable groups per molecule and a fluorine content of at least 35.0 by mass relative to the molecular weight of the compound and, when polymerized at the polymerizable groups, having a calculated molecular weight between every adjacent crosslink points of 300 or smaller. Examples of such a monomer compound include compounds X-2 to 4, X-6, X-8 to 14, and X-21 to 32 shown in paras. [0023] to [0027] of JP 2006-28409A and compound X-33 of formula:

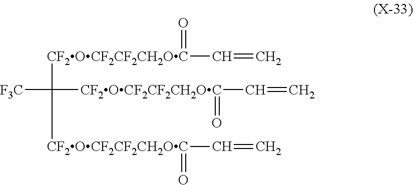

Compounds M-1 to M-16 described in paras. [0062] to [0065] of JP 2006-284761A and compounds MA1 through MA20 shown below are also preferred.

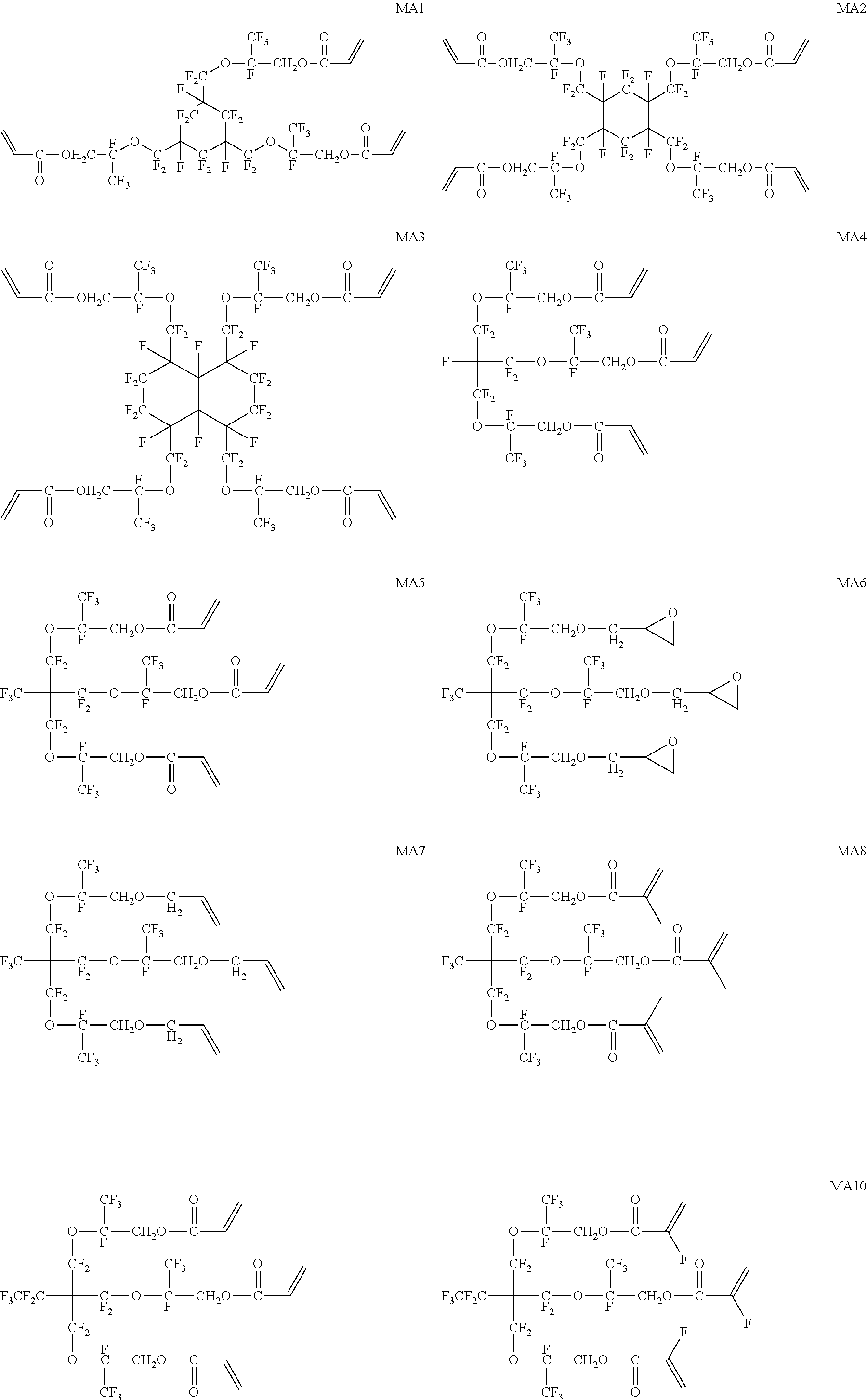

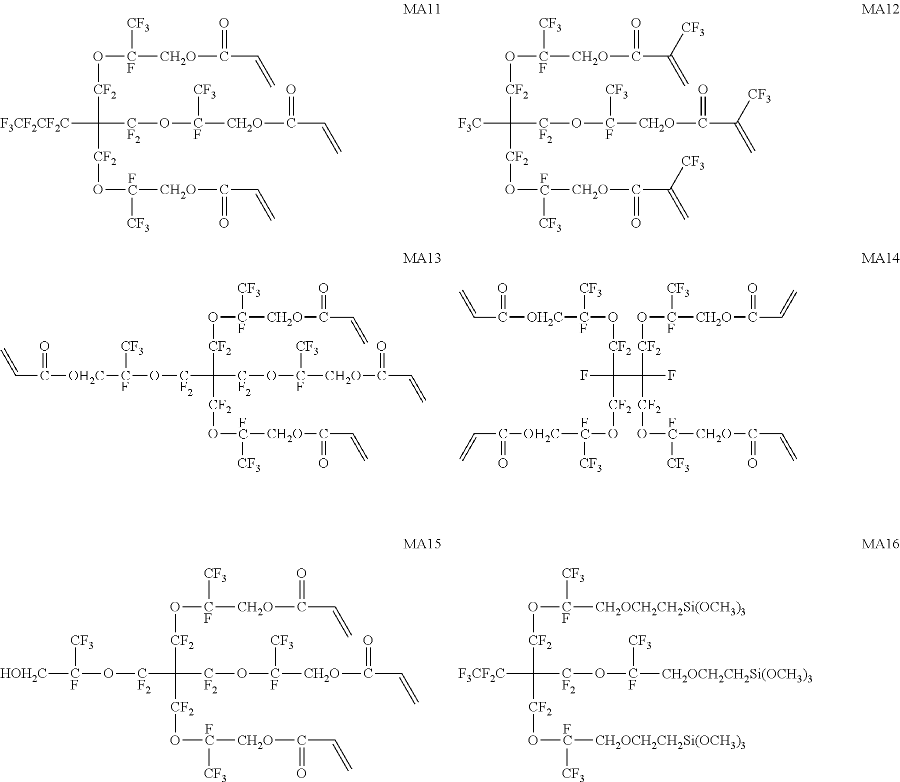

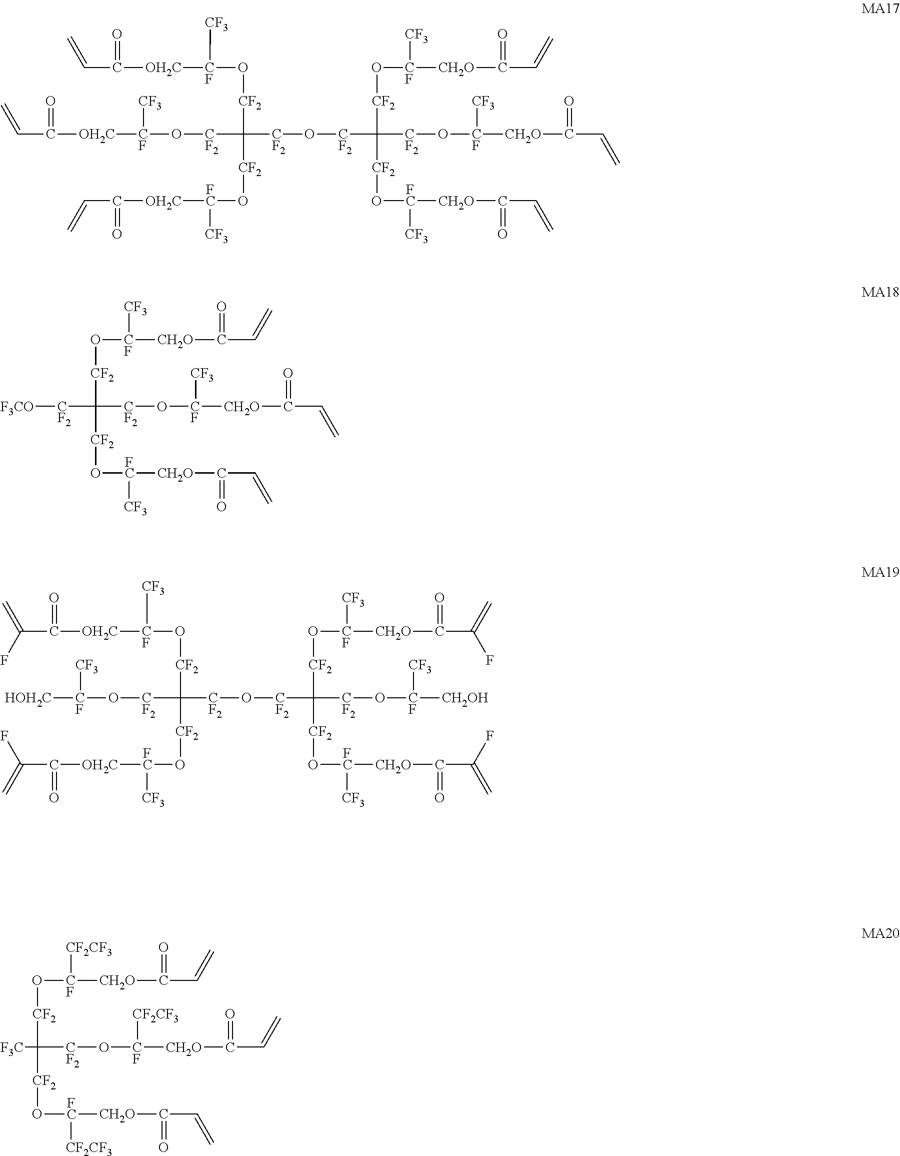

Preferred of these fluorine-containing polyfunctional compounds are compounds X-22 and M-1 shown below in terms of scratch resistance and low refractive index.

Compound M-1 is more preferred.

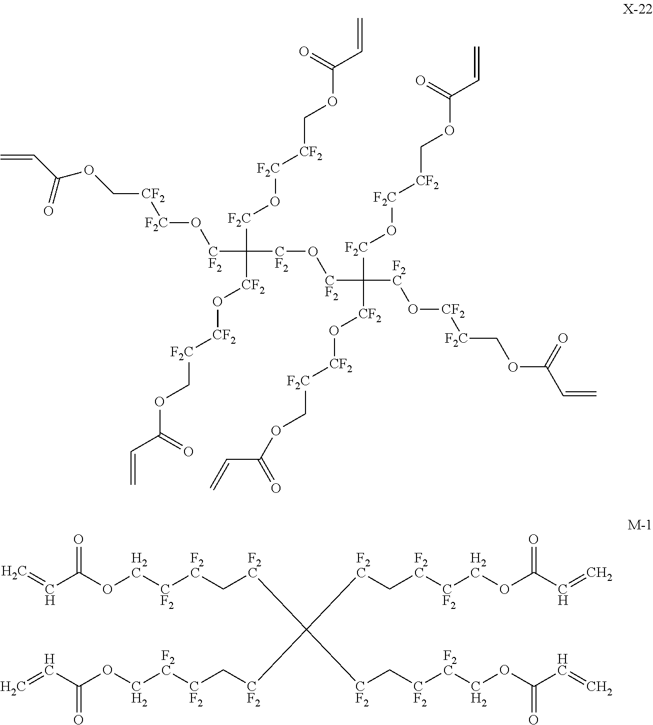

The compounds described in WO2005/059601, paras. 0135 to 0149 and the compounds described in JP 2006-291077A, paras. 0014 to 0028 are also suitably used.

### <Porous or Hollow Silica Particle>

In order to reduce the refractive index, it is particularly preferred to incorporate porous or hollow particles into the low refractive index layer. The porous or hollow particles preferably have a porosity or void of 10% to 80%, more preferably 20% to 60%, even more preferably 30% to 60%. Hollow particles with a void falling within that range are preferred in terms of reduction of refractive index and retention of durability.

In the case of using porous or hollow silica particles, the refractive index of the particles is preferably 1.10 to 1.40, more preferably 1.15 to 1.35, even more preferably 1.15 to 1.30, the term “refractive index” being defined not as the refractive index of the outer silica shell of a hollow particle but as that of the whole particle.

The method of making porous or hollow silica particles is described, e.g., in JP 2001-233611A or JP 2002-796161A. Hollow silica particles of which the outer shell has closed pores are particularly preferred. The refractive index of the hollow silica particles may be calculated by the method described in JP 2002-79616A.

The content of the porous or hollow silica in the coating composition providing the low refractive index layer is preferably such that the particles are applied in an amount of 1 to 100 mg/m², more preferably 5 to 80 mg/m², even more preferably from 10 to 60 mg/m². Addition of too small an amount of the particles is little effective in reducing the refractive index and improving scratch resistance. Addition of too much particles results in surface unevenness of the low refractive index layer, which may impair the display quality, such as depth of black, and reduce the integrated reflectance.

The average particle size of the porous or hollow silica particles is preferably 30% to 150%, more preferably 35% to 80%, even more preferably 40% to 60%, of the thickness of the low refractive index layer. When the thickness of the low refractive index layer is 100 nm, for example, the particle size of the hollow silica particles is preferably 30 to 150 nm, more preferably 35 to 100 nm, even more preferably 40 to 65 nm.

The porous particles for use in the invention may have a size distribution with a variation coefficient of preferably 5% to 60%, more preferably 10% to 50%. Two or more kinds of particles different in average particle size may be used in combination.

Addition to too small silica particles provides only a low porosity or void, which is insufficient to reduce the refractive index. Addition of too much particles results in surface unevenness of the low refractive index layer, which may impair the display quality, such as depth of black, and reduce the integrated reflectance. The silica particles may be crystalline or amorphous. The silica particles are preferably monodisperse: The shape of the particles is most preferably spherical but may be amorphous.

Two or more kinds of hollow silica particles different in average particle size may be used in combination. The average particle size of the hollow silica particles may be determined by electron microscopy.

The hollow silica particles preferably have a specific surface area of 20 to 300 m²/g, more preferably 30 to 120 m²/g, even more preferably 40 to 90 m²/g, measured by BET method using nitrogen as adsorption gas.

Nonporous silica particles may be used in combination with the hollow silica. The nonporous silica particles to be used in combination preferably have a particle size of 30 to 150 nm, more preferably 35 to 100 nm, most preferably 40 to 80 nm.

### <Surface Treatment of Inorganic Particle>

Surface treatment of the inorganic particles will be described taking porous or hollow inorganic particles for instance. It is preferred that the inorganic particles be surface treated with a hydrolysate of an organosilane compound and/or a partial condensate thereof to have improved dispersibility in the coating composition providing the low refractive index layer. The surface treatment is preferably carried out in the presence of an acid catalyst and/or a metal chelate compound. The structure of the organosilane is not particularly limited but preferably has a (meth)acryloyl group at the terminal thereof.

### <Organosilane Compound>

At least one of the layers making up the optical film of the invention is preferably formed of a coating composition containing at least one component selected from a hydrolysate of an organosilane compound and a partial condensate of the hydrolysate to provide improved scratch resistance. This component will sometimes be called a sol component. Particularly when the optical film is used as an antireflection film, it is preferred to incorporate the sol component into the low refractive index layer to obtain both antireflection performance and scratch resistance. After applying the coating composition, the sol component undergoes condensation reaction during the subsequent step of drying and heating to cure and become part of the binder of the layer. In the case when the cured product has a polymerizable unsaturated bond, it polymerizes on irradiation with active rays to form a binder having a three dimensional structure.

The organosilane compound is preferably represented by formula (1):

(R₁)ₘ—Si(X)₄₋ₘ (1)

wherein R₁ represents a substituted or unsubstituted alkyl group or a substituted or unsubstituted aryl group; X represents a hydroxyl group or a hydrolyzable group; and m represents an integer of 1 to 3.

The alkyl as R₁ is preferably C1-C30 alkyl, more preferably C1-C16 alkyl, even more preferably C1-C6 alkyl, such as methyl, ethyl, propyl, isopropyl, hexyl, decyl, or hexadecyl.

The aryl as R₁ is preferably phenyl or naphthyl, more preferably phenyl. X is preferably alkoxy (more preferably C1-C5 alkoxy, e.g., methoxy or ethoxy), halogen (e.g., Cl, Br, or I), or R²COO (wherein R² is hydrogen or C1-C6 alkyl) (e.g., CH₃COO or C₂H₅COO). X is more preferably alkoxy, even more preferably methoxy or ethoxy. m is an integer of 1 to 3, preferably 1 or 2.

Examples of the substituent of the substituted alkyl and aryl groups as R₁ include, but are not limited to, halogen (e.g., F, Cl, or Br), hydroxyl, mercapto, carboxyl, epoxy, alkyl (e.g., methyl, ethyl, isopropyl, propyl, or t-butyl), aryl (e.g., phenyl or naphthyl), aromatic heterocyclic (e.g., furyl, pyrazolyl, or pyridyl), alkoxy (e.g., methoxy, ethoxy, isopropoxy, or hexyloxy), aryloxy (e.g., phenoxy), alkylthio (e.g., methylthio or ethylthio), arylthio (e.g., phenylthio), alkenyl (e.g., vinyl or 1-propenyl), acyloxy (acetoxy, acryloyloxy, or methacryloyloxy), alkoxycarbonyl (e.g., methoxycarbonyl or ethoxycarbonyl), aryloxycarbonyl (e.g., phenoxycarbonyl), carbamoyl (e.g., carbamoyl, N-methylcarbamoyl, N,N-dimethylcarbamoyl, or N-methyl-N-octylcarbamoyl), and acylamino (e.g., acetylamino, benzoylamino, acrylamino, or methacrylamino). The substituents may further be substituted.

R₁ is preferably substituted alkyl or substituted aryl.

An organosilane compound having a vinyl polymerizable substituent and represented by formula (2), which is synthesized starting with the compound of formula (1), is also preferably used.

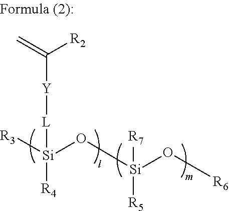

wherein R₂ represents a hydrogen atom, a methyl group, a methoxy group, an alkoxycarbonyl group, a cyano group; a fluorine atom, or a chlorine atom; Y represents a single bond, *—COO—**, *—CONH—**, or *—O—**, wherein * indicates the position to bond to ═C(R₂)—, and ** the position to bond to L; L represents a divalent linking group; l represents a number satisfying the relation: l=100-m; m represents a number of 0 to 50; R₃, R₄, and R₅ each represent a halogen atom, a hydroxyl group, an unsubstituted alkoxy group, or an unsubstituted alkyl group; R₆ represents a hydrogen atom or an alkyl group; and R₇ represents the same group as defined by R₁ in formula (1) or a hydroxyl group.

Examples of the alkoxycarbonyl as R₂ are methoxycarbonyl and ethoxycarbonyl. R₂ is preferably hydrogen, methyl, methoxy, methoxycarbonyl, cyano, fluorine, or chlorine, with hydrogen, methyl, methoxycarbonyl, fluorine, or chlorine being more preferred, and with hydrogen or methyl being even more preferred.

Y is preferably a single bond, *—COO—**, or *—CONH—**, more preferably a single bond or *—COO—**, even more preferably *—COO—**.

Examples of the linking group as L include substituted or unsubstituted alkylene, substituted or unsubstituted arylene, substituted or unsubstituted alkylene having therein a linking group (e.g., ether, ester or amido linkage), and substituted or unsubstituted arylene having therein a linking group (e.g., ether, ester or amido linkage), with substituted or unsubstituted alkylene, substituted or unsubstituted arylene, and alkylene having therein a linking group being preferred, with unsubstituted alkylene, unsubstituted arylene, and alkylene having therein an ether or ester linkage being more preferred, with unsubstituted alkylene and alkylene having therein an ether or ester linkage being even more preferred. The substituent may be halogen, hydroxyl, mercapto, carboxyl, epoxy, alkyl, aryl, and so on, each of which may further be substituted.

m is preferably 0 to 40, more preferably 0 to 30.

Each of R₃, R₄, and R₅ is preferably chlorine, hydroxyl, or unsubstituted C₁-C₆ alkoxy, with hydroxyl or C1-C3 alkoxy being more preferred, and with hydroxyl or methoxy being even more preferred.

The alkyl as R₆ is preferably methyl or ethyl. R₇ is preferably hydroxyl or unsubstituted alkyl, with hydroxyl or C1-C3 alkyl being more preferred, and with hydroxyl or methyl being even more preferred.

The compounds of formula (1) may be used in combination of two or more thereof. In particular, the compound of formula (2) is synthesized by using two of the compounds of formula (1). Specific but non-limiting examples of the compounds of formula (1) and of the starting compounds for synthesizing the compounds of formula (2) are shown below.

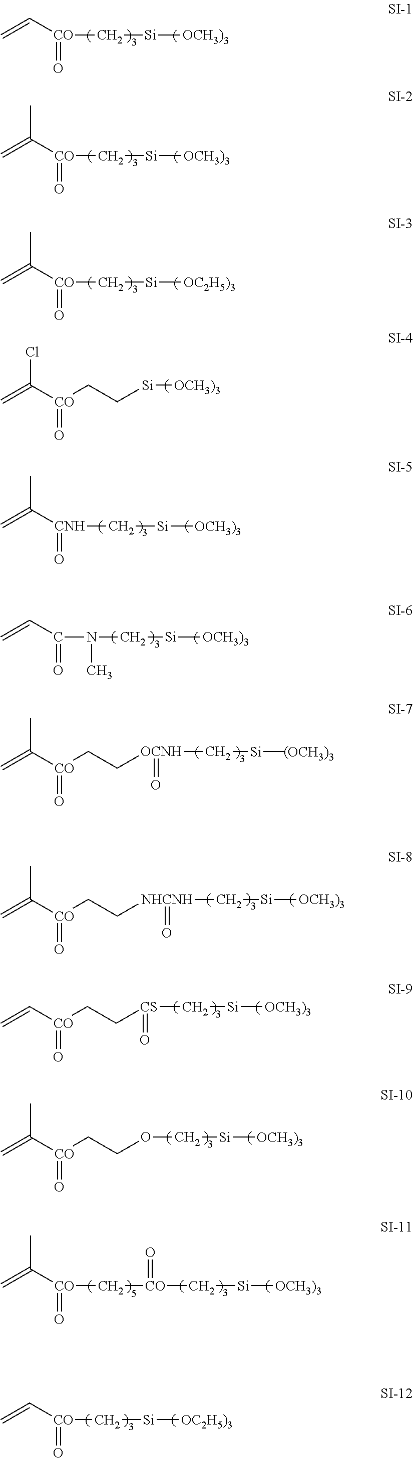

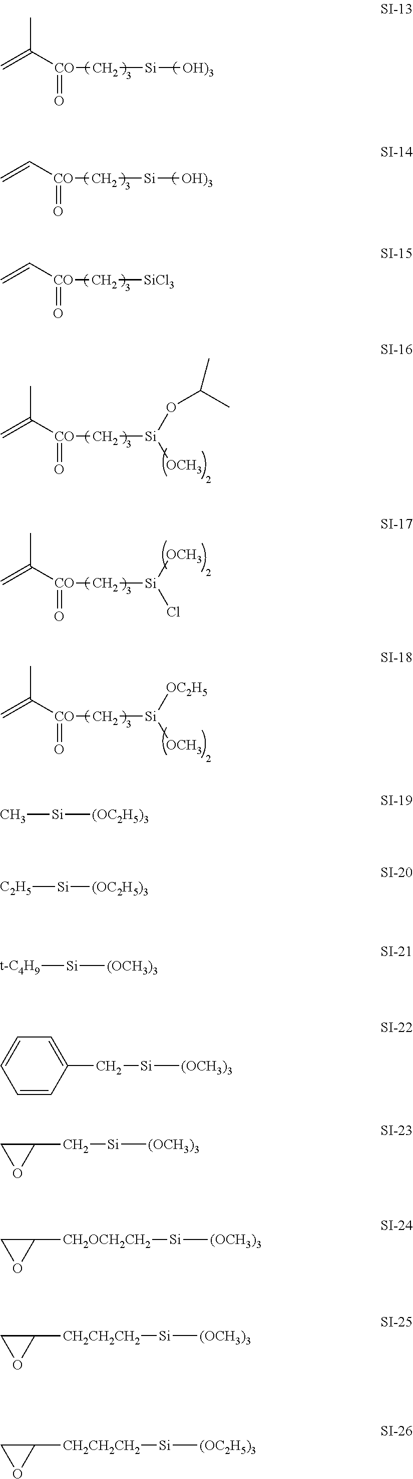

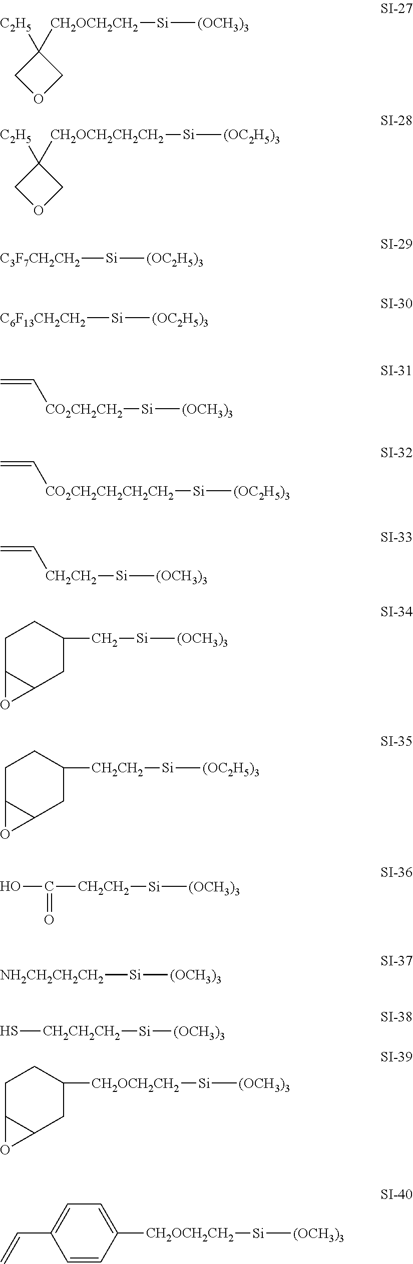

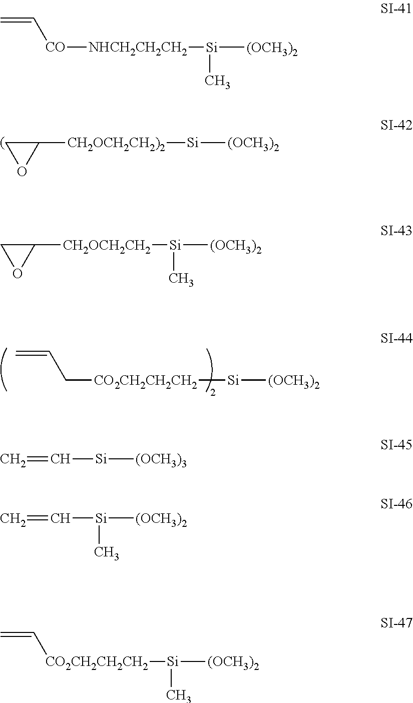

### SI-48 Methyltrimethoxysilane

In order to obtain the desired effects, it is preferred for the organosilane hydrolysate and/or its partial condensate to contain the hydrolysate and/or its partial condensate of the organosilane having a vinyl polymerizable group in an amount of 30% to 100%, more preferably 50% to 100%, even more preferably 70% to 95%, by mass based on the total amount of the organosilane hydrolysate and/or its partial condensate.

To stabilize the properties of an applied coating composition, it is preferred that at least one of the organosilane hydrolysate and the partial condensate thereof have minimized volatility, specifically have a volatilization rate of 5 mass % or less, more preferably 3 mass % or less, even more preferably 1 mass % or less, per hour at 105° C.

The sol component for use in the invention is prepared by hydrolysis and/or partial condensation of the organosilane. The hydrolytic condensation reaction is carried out in the presence of a catalyst hereinafter described and 0.05 to 2.0 mol, preferably 0.1 to 1.0 mol, of water per mole of the hydrolyzable group X at 25 to 100° C.

In the organosilane hydrolysate and/or its partial condensate, the mass average molecular weight of the hydrolysate and/or its partial condensate of the organosilane having the vinyl polymerizable group from which components of molecular weights less than 300 are removed preferably ranges from 450 to 20,000, more preferably 500 to 10,000, even more preferably 550 to 5,000, and most preferably 600 to 3,000. The mass average molecular weight and the molecular weight as referred to here are polystyrene equivalent molecular weights measured using a GPC analyzer equipped with TSKgel GMHxL, TSKgel G4000HxL, and TSKgel G2000HxL columns (all available from Tosoh Corp.), tetrahydrofuran as a solvent, and a differential refractometer detector. The content of components having a certain molecular weight range higher than 300 is expressed in terms of the percentage of the peak area of the molecular weight range of interest to the total peak area of the components having molecular weights higher than 300.

The sol component preferably has a polydispersity index, i.e., mass average molecular weight/number average molecular weight, of 3.0 to 1.1, more preferably 2.5 to 1.1, even more preferably 2.0 to 1.1, and most preferably 1.5 to 1.1.

The organosilane hydrolysate and its partial condensate for use in the invention will be described in greater detail.

The hydrolysis reaction of the organosilane and the subsequent condensation reaction are generally carried out in the presence of a catalyst. Suitable catalysts include inorganic acids, such as hydrochloric acid, sulfuric acid, and nitric acid; organic acids, such as oxalic acid, acetic acid, butyric acid, maleic acid, citric acid, formic acid, methanesulfonic acid, and toluenesulfonic acid; inorganic bases, such as sodium hydroxide, potassium hydroxide, and ammonia; organic bases, such as triethylamine and pyridine; metal alkoxides, such as triisopropoxyaluminum, tetrabutoxyzirconium, tetrabutyl titanate and dibutyltin dilaurate; metal chelate compounds having Zr, Ti, Al, etc. as a central metal; and fluorine-containing compounds, such as KF and NH₄F. Either one of these catalysts or a combination of two or more thereof may be used.

The hydrolytic condensation of the organosilane can be carried out with or without a solvent. It is preferable to use an organic solvent so as to mix the components uniformly. Suitable solvents include alcohols, aromatic hydrocarbons, ethers, ketones, and esters. Solvents capable of dissolving both the organosilane and the catalyst are preferred. From the viewpoint of production procedure, it is favorable that the organic solvent used to carry out the reaction also serves as at least a part of the solvent of the finally prepared coating composition. In this regard, it is preferred that the organic solvent as a reaction solvent would not impair the solubility or dispersibility of other materials such as the fluorocopolymer when mixed therewith to prepare a coating composition.

The reaction is conducted by adding to the organosilane 0.05 to 2 mol, preferably 0.1 to 1 mol, per mol of the hydrolyzable group on the organosilane as stated above, and the system is stirred at 25° to 100° C. in the presence or absence of the solvent and in the presence of the catalyst.

The coating composition containing the sol component and the metal chelate compound preferably further contains at least one of a β-diketone compound and a β-ketoester compound.

The content of the organosilane hydrolysate and its partial condensate in the coating composition is preferably small in the case of forming an antireflection layer, which is relatively thin, and preferably large in the case of forming a hardcoat layer, which is relatively thick. Taking into consideration manifestation of the effect, refractive index, and form and surface conditions of the coating layer, the content of the organosilane hydrolysate and its partial condensate is preferably 0.1% to 50%, more preferably 0.5% to 30%, even more preferably 1% to 15%, by mass relative to the total solid content of the layer formed.

### <Transparent Substrate>

The transparent substrate of the optical film of the invention is not particularly limited and may be a transparent resin film, plate, or sheet or a transparent glass plate or sheet. Examples of the transparent resin film include cellulose acylate film (e.g., cellulose triacetate film with a refractive index of 1.48, cellulose diacetate film, cellulose acetate butyrate film, or cellulose acetate propionate film), polyester film (e.g., polyethylene terephthalate film), polyether sulfone film, polyacrylic resin film, polyurethane resin film, polycarbonate film, polysulfone film, polyether film, polymethylpentene film, polyether ketone film, and (meth)acrylonitrile film.

The thickness of the substrate is usually about 25 to 1000 μm, preferably 25 to 250 μM, more preferably 30 to 90 μM. While the substrate may have any width, the width is usually 100 to 5000 mm, preferably 800 to 3000 mm, more preferably 1000 to 2000 mm, in terms of ease of handling, yield, and productivity. The substrate preferably has a smooth surface with an average roughness Ra of not more than 1 μm, more preferably 0.0001 to 0.5 μm, even more preferably 0.001 to 0.1 μm.

### <Cellulose Film>

Of various films recited above, preferred is a cellulose acylate film that is commonly used as a protective film of a polarizing plate because of its high transparency, low optical birefringence, and ease of production. Various techniques are known for improving the mechanical characteristics, transparency, planarity, and the like of a cellulose acylate film. For example, the technique disclosed in Journal of Technical Disclosure 2001-1745 is applicable to the film for use in the invention.

Of cellulose acylate films particularly preferred for use in the invention is a cellulose triacetate film. A film of cellulose acetate having an acetic acid content of 59.0% to 61.5% is preferably used. As used herein, the term “acetic acid content” is defined as the percent mass ratio of acetic acid moiety combined to the cellulose unit mass. The acetic acid content can be measured and calculated here according to ASTM D-817-91 (Standard test methods of testing cellulose acetate propionate and cellulose acetate butyrate).

The cellulose acylate preferably has a viscosity average degree of polymerization of 250 or higher, more preferably 290 or higher.

The cellulose acylate preferably has a narrow molecular weight distribution, specifically an Mw/Mn value (Mw: mass average molecular weight; Mn: number average molecular weight) close to 1.0 as obtained by GPC. The cellulose acylate preferably has an Mw/Mn value in the range of from 1.0 to 1.7, more preferably from 1.3 to 1.65, even more preferably 1.4 to 1.6.

In general, the degree of substitution of the hydroxyl groups at the 2-, 3-, and 6-positions of the glucose unit of the cellulose acylate is not equally distributed among the 2-, 3-, and 6-positions but is inclined to be less at the 6-position. In the present invention, it is preferred that the degree of substitution of the hydroxyl group be larger at the 6-position than at the 2- and 3-positions. Specifically, the degree of acyl substitution of the 6-position hydroxyl group is preferably 32% or larger, more preferably 33% or larger, even more preferably 34% or larger, relative to the total degree of substitution. More specifically, the degree of acyl substitution of the 6-position hydroxyl group is preferably 0.88 or larger. The substituent at the 6-position may be not only an acetyl group but also an acyl group with 3 or more carbon carbons, such as propionyl, butyloyl, valeroyl, benzoyl, or acryloyl. The degree of substitution at each position may be determined by NMR analysis.

Examples of cellulose acylates suited for use in the invention include cellulose acetates obtained by the procedures described in JP 11-5851A, paras. 0043 to 0044 (Example and Synthesis Example 1), paras. 0048 to 0049 (Synthesis Example 2), and paras. 0051 to 0052 (Synthesis Example 3).

### III. Polarizing Plate

The polarizing plate according to the third aspect of the invention includes a pair of protective films and a polarizer interposed between the protective films. At least one of the protective films is the optical film of the invention.

### IV. Image Display Apparatus

The optical film or the polarizing plate according to the invention are suited for use as an antireflection film of various display apparatus. The antireflection film of the invention is useful in image display apparatus, such as LCDs, PDPs, ELDs, CRTs, field emission displays (FEDs), and surface-conduction electron-emitter displays (SEDs), to prevent contrast reduction due to reflection of ambient light and image light.

The image display apparatus, especially an LCD, of the invention has the optical film or the polarizing plate of the invention. The optical film or the polarizing plate is preferably disposed on the front side (viewer's side) of the display.

The invention will now be illustrated in greater detail with reference to Examples, but it should be understood that the invention is not deemed to be limited thereto. Unless otherwise noted, all the parts and percents are by mass.

### Example 1

(1) Preparation of coating compositions 1 to 15 for hardcoat layer Formulation of coating composition 1:

| | | |
|---|---|---|
| PET-30 | 21.4 | parts |
| Viscoat 360 | 21.4 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 2:

| | | |
|---|---|---|
| PET-30 | 21.4 | parts |
| Viscoat 360 | 21.4 | parts |
| M-0 | 0.03 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 3:

| | | |
|---|---|---|
| PET-30 | 21.3 | parts |
| Viscoat 360 | 21.3 | parts |
| M-0 | 0.08 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 4:

| | | |
|---|---|---|
| PET-30 | 21.2 | parts |
| Viscoat 360 | 21.2 | parts |
| M-0 | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 5:

| | | |
|---|---|---|
| PET-30 | 20.7 | parts |
| Viscoat 360 | 20.7 | parts |
| M-0 | 1.38 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 6:

| | | |
|---|---|---|
| PET-30 | 20.4 | parts |
| Viscoat 360 | 20.4 | parts |
| M-0 | 1.93 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 7:

| | | |
|---|---|---|
| PET-30 | 21.2 | parts |
| Viscoat 360 | 21.2 | parts |
| M-1 | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 8:

| | | |
|---|---|---|
| PET-30 | 21.2 | parts |
| Viscoat 360 | 21.2 | parts |
| Diethylene glycol | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 9:

| | | |
|---|---|---|
| PET-30 | 21.2 | parts |
| Viscoat 360 | 21.2 | parts |
| Isopropyl alcohol | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 10:

| | | |
|---|---|---|
| PET-30 | 21.2 | parts |
| Viscoat 360 | 21.2 | parts |
| 2-Hydroxyethyl acrylate | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 11:

| | | |
|---|---|---|
| PET-30 | 21.2 | parts |
| Viscoat 360 | 21.2 | parts |
| M-2 | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 12:

| | | |
|---|---|---|
| PET-30 | 18.2 | parts |
| Viscoat 360 | 18.2 | parts |
| M-0 | 0.28 | parts |
| Irgacure 127 | 1.23 | parts |
| Z-7404 | 25.4 | parts |
| Methyl isobutyl ketone | 2.7 | parts |
| Methyl ethyl ketone | 34.24 | parts |
| SP-13 | 0.03 | parts |

Formulation of coating composition 13:

| | | |
|---|---|---|
| PET-30 | 42.7 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 14:

| | | |
|---|---|---|
| PET-30 | 42.4 | parts |
| M-0 | 0.28 | parts |
| Irgacure 127 | 1.28 | parts |
| MEK-ST | 29.3 | parts |
| MIBK-ST | 7.3 | parts |
| Methyl isobutyl ketone | 6.1 | parts |
| Methyl ethyl ketone | 13.2 | parts |
| SP-13 | 0.03 | parts |

Formulation of coating composition 15:

| | | |
|---|---|---|
| PET-30 | 39.2 | parts |
| Viscoat 360 | 39.2 | parts |
| M-0 | 0.28 | parts |
| Irgacure 127 | 2.35 | parts |
| Methyl isobutyl ketone | 6.1 | parts |
| Methyl ethyl ketone | 13.2 | parts |
| SP-13 | 0.03 | parts |

Each of the formulations described above was filtered through a polypropylene depth filter having a pore size of 5 μm and then through a polypropylene depth filter having a pore size of 0.5 μm to prepare coating compositions 1 through 15 for hardcoat layer.

Materials used in the above formulations are as follows.

PET-30: mixture of pentaerythritol triacrylate and pentaerythritol tetraacrylate (available from Nippon Kayaku)
Viscoat 360: trimethylolpropane ethylene oxide-modified triacrylate (from Osaka Organic Chemical Industry)
Irgacure 127: polymerization initiator from Ciba Specialty Chemicals
MEK-ST: methyl ethyl ketone (MEK) solution of organosilica sol; solid content: 30%; average particle size: 15 nm (from Nissan Chemical Industries, Ltd.)
MIBK-ST: methyl isobutyl ketone (MIBK) solution of organosilica sol; solid content: 30%; average particle size: 15 nm (from Nissan Chemical Industries)
SP-13: MEK solution (solid content: 40%) of polymer of formula below (mass average molecular weight: 19000)

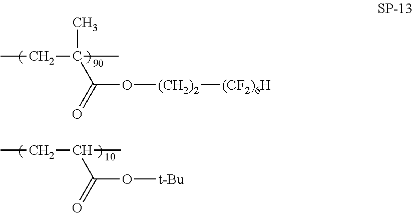

wherein the FIGS. 90 and 10 indicate the mass fractions of the respective repeating units.
M-0: glycerol monomethacrylate (from NOF)
M-1: ethylene oxide-modified phosphoric acid acrylate of formula:

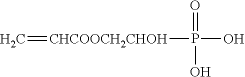

M-2: epichlorohydrin-modified phthalic acid diacrylate

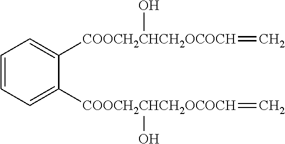

Z-7404: hardcoat composition containing zirconia particles (average particle size: 15 nm) (from JSR Corp.)
(2) Preparation of coating composition LL-1 for low refractive index layer
(2-1) Synthesis of ethylenically unsaturated group-containing fluoropolymer A (methacryl-modified fluoropolymer)

A hydroxyl-containing fluoropolymer was prepared as follows. A 2.0 liter-volume stainless steel autoclave equipped with an electromagnetic stirrer having been thoroughly purged with nitrogen gas was charged with 400 g of ethyl acetate, 53.2 g of perfluoro(propyl vinyl ether), 36.1 g of ethyl vinyl ether, 44.0 g of hydroxyethyl vinyl ether, 1.00 g of lauroyl peroxide, 6.0 g of azo-containing polydimethylsiloxane (VPS 1001®, from Wako Pure Chemical Industries, Ltd.), and 20.0 g of an nonionic reactive emulsifier (NE-30®, from ADEKA Corp., see below). The mixture was cooled to −50° C. in a dry ice-methanol bath, and the autoclave was again purged with nitrogen gas to remove oxygen from the system.

To the mixture was added 120.0 g of hexafluoropropylene, and the temperature of the autoclave was raised. When the temperature reached 60° C., the pressure was 5.3×10⁵ Pa. The reaction was continued at 70° C. for 20 hours while stirring. When the pressure decreased to 1.7×10⁵ Pa, the autoclave was cooled with water to cease the reaction. After the temperature reached room temperature, the unreacted monomers were released, and the autoclave was then opened to collect a polymer solution having a solid concentration of 26.4%. The resulting polymer solution was poured into methanol to precipitate the polymer, which was washed with methanol and dried in vacuo at 50° C. to give 220 g of a hydroxyl-containing fluoropolymer. The amounts of the monomers and the solvent used in the reaction are shown in Table 1.

TABLE 1

| | |
|---|---|
| | Hydroxyl-containing |
| Monomer and Solvent | Fluoropolymer |

| | | | |
|---|---|---|---|
| Addition | Hexafluoropropylene | 120.0 | g |
| Amount | Perfluoro(propyl vinyl ether) | 53.2 | g |
| (g) | Ethyl vinyl ether | 36.1 | g |
| | Hydroxyethyl vinyl ether | 44.0 | g |
| | Lauroyl peroxide | 1.0 | g |
| | VPS1001 | 6.0 | g |
| | NE-30 | 20.0 | g |
| | Ethyl acetate | 400.0 | g |

The polystyrene equivalent average molecular weight of the hydroxyl-containing fluoropolymer was determined by GPC. The ratios of the monomer units making up the hydroxyl-containing fluoropolymer were determined by. ¹H-NMR and ¹³C-NMR analyses. The results obtained are shown in Table 2.

TABLE 2

| | Monomer | OH-containing Polymer |
|---|---|---|
| Ratio of | hexafluoropropylene | 41.1 |
| Monomer | perfluoro(propyl vinyl ether) | 10.0 |
| Units | ethyl vinyl ether | 20.9 |
| (mol %) | hydroxyethyl vinyl ether | 24.8 |
| | NE-30 | 0.8 |

| | |
|---|---|
| Polydimethylsiloxane structure (mol %) | 2.4 |
| Number average molecular weight | 34,000 |

NE-30 is a nonionic reactive emulsifier represented by formula below, wherein n=9, m=1, and u=30:

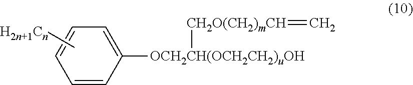

An ethylenically unsaturated group-containing fluoropolymer A was synthesized using the resulting hydroxyl-containing fluoropolymer as follows. A one-liter separable flask equipped with an electromagnetic stirrer, a glass condenser, and a thermometer was charged with 50.0 g of the hydroxyl-containing fluoropolymer prepared in Example, 0.01 g of 2,6-di-t-butylmethylphenol as a polymerization inhibitor, and 370 g of methyl isobutyl ketone (MIBK), and the mixture was stirred at 20° C. until the hydroxyl-containing fluoropolymer dissolved in MIBK to provide a transparent solution.

To the solution was added 15.1 g of 2-methacryloyloxyethyl isocyanate and stirred until dissolved. To the solution was added 0.1 g of dibutyltin dilaurate to start reaction. The stirring was continued for 5 hours while maintaining the system at 55° to 65° C. to give an MIBK solution of an ethylenically unsaturated group-containing fluoropolymer A.

A 2 g aliquot of the resulting polymer solution weighed out on an aluminum dish was dried on a 150° C. hot plate for 5 minutes and weighed. The solid content of the polymer solution was thus calculated to be 15.2%. The amounts of the compounds and the solvent used and the solid content are shown in Table 3.

TABLE 3

| | |
|---|---|
| | Ethylenically |
| | Unsaturated |
| | Group-containing |
| Addition Amount | Fluoropolymer A |

| | | |
|---|---|---|
| Hydroxyl-containing fluoropolymer | 50.0 | g |
| 2-Methacryloyloxyethyl isocyanate | 15.1 | g |
| 2,6-Di-t-butylmethylphenol | 0.01 | g |
| Dibutyltin dilaurate | 0.1 | g |
| Methyl isobutyl ketone | 370 | g |

| | |
|---|---|
| Ratio of 2-methacryloyloxyethyl isocyanate to | 1.1 |
| hydroxyl content of hydroxyl-containing | |
| fluoropolymer | |
| Solid content | 15.2% |

(2-2) Preparation of coating composition for low refractive index layer

A separable flask of glass equipped with a stirrer was charged with 19 parts of the MIBK solution of the ethylenically unsaturated group-containing fluoropolymer A, 8 parts of PET-30 (pentaerythritol triacrylate/pentaerythritol tetraacrylate mixture, from Nippon Kayaku), 15 parts of acryl-modified perfluoropropylene oxide B-3, 52 parts, on a solid basis, of hollow silica particles (JX-1012SIV, from Catalysts & Chemicals Industries, Co., Ltd.), 2.7 parts of a photopolymerization initiator of formula (16) shown below (Irgacure 127, from Ciba Specialty Chemicals), 1.1 parts of Rad 2600 (from Evonik Tego Chemie Service GmbH), 0.5 parts of Rad 2500 (from Evonik Tego), 1.1 parts of Silaplane FM-0725 (from Chisso Corp.), and MEK of an amount to give a final solids concentration of 5%, and the mixture was stirred at room temperature for 1 hour, followed by filtration through a polypropylene depth filter having a pore size of 0.5 μm to provide coating composition LL-1 for low refractive index layer.

The compounds used in the preparation of coating composition LL-1 are as follows. Rad 2600: copolymer having a number average molecular weight of 16,000 and comprising a repeating unit of formula (17) and six repeating units of formula (18) (from Evonik Tego).

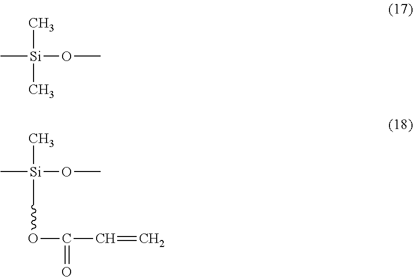

Rad 2500: copolymer having a number average molecular weight of 15.00 and comprising a repeating unit of formula (17) and two repeating units of formula (18) (from Evonik Tego).
PET-30: pentaerythritol triacrylate/pentaerythritol tetraacrylate mixture, from Nippon Kayaku. Acryl-modified perfluoropropylene oxide B-3: compound B-1, wherein R^{b}=H.

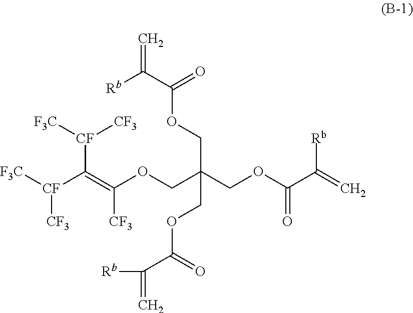

JX-1012SIV: hollow silica particles available from Catalysts & Chemicals Industries, Co., Ltd.; number average particle size: 0.050 μm; silica particles concentration: 20%; solvent: isopropyl alcohol/MIBK=3/7)
Irgacure 127: compound of formula (16), from Ciba Specialty Chemicals:

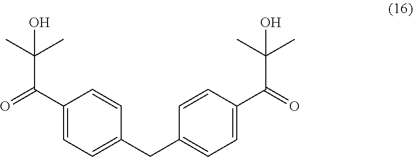

Silaplane FM-0725: silicone compound of formula (24), from Chisso Corp.; number average molecular weight: 10,000

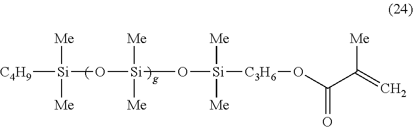

wherein g is an integer giving a number average molecular weight of 10,000.
(3) Formation of hardcoat layer and low refractive index layer

Each of the coating compositions 1 through 15 for hardcoat layer was applied a continuous unrolled web of a triacetyl cellulose film (TAC-TD80U, from Fujifilm Corp.) using a slot die coater described in FIG. 1 of JP 2003-211052A at a wet coverage rate of 30 cc/m², dried at 25° C. for 15 seconds and then at 60° C. for 30 seconds, and cured by irradiating with UV rays at a dosage of 120 mJ/cm² from a high pressure mercury lamp having a power of 160 W/cm (from Dr. Honle AG) under nitrogen purge to form a 13 μm-thick hardcoat layer, designated HC-1 through HC-15. Similarly, the coating compositions 2 to 15 are applied to form hardcoat layers HC-2 to HC-15.

The coating composition LL-1 for low refractive index layer was applied to the hardcoat layer using the same slot die coater as used above to a dry thickness of 90 nm, dried at 25° C. for 15 seconds and then at 60° C. for 30 seconds, and irradiated with UV rays at a dosage of 300 mJ/cm² from a high pressure mercury lamp having a power of 240 W/cm (from Dr. Honle AG) in an environment with an oxygen concentration kept at 100 ppm or less by purging with nitrogen gas to form a low refractive index layer. The resulting optical film with antireflection function, designated HL-1 through HL-15, was taken up into roll. The coating operations described above were carried out in a class 100 clean room. An optical film having a hardcoat layer HC-4 formed as described above but having no low refractive index layer thereon was prepared, which was designated optical film HL-16.

(4) Evaluation of optical films

The optical films were evaluated for point defects, reflectance, and pencil hardness according to the following procedures. The results of evaluation are shown in Table 4.

(4-1) Point defects

The point defects on the surface of each optical film were counted with the naked eye. The size of the point defects observable with the naked eye was 50 μm or greater. The number of point defects was expressed in terms of number per m². Numbers of point defects of 0.5/m² or fewer are rated as pass.

### (4-2) Reflectance

Specular reflectance of each optical film was measured for light rays of 380 to 780 nm at an incident angle of 5° and an output angle of −5° using a spectrophotometer V-550 (from JASCO Corp.) equipped with an adaptor ARV-474 (from JASCO Corp.). An average reflectance in a wavelength range of 450 to 650 nm was calculated to evaluate antireflection performance.

(4-3) Pencil hardness

The hardness of each optical film was evaluated by a pencil hardness test according to JIS K5400. Pencil hardness values of 2H or higher are rated as pass.

### (4-4) Haze

The haze of each optical film was measured with a hazemeter ND-1001DP (from Nippon Denshoku Kogyo) in accordance with the procedures specified in JIS K7361-1.

TABLE 4

| | | (b) Ionizing Radiation Curing, | | Low | | | | | | | | |
|---|---|---|---|---|---|---|---|---|---|---|---|---|
| | (a) Inorganic | Binder Forming Material | | Refrac- | | | | | | | | |
| | Particles | Polyfunctional | Alkylene Oxide- | tive | Additive | | Point | Pencil | | | Reflect | |
| Optical | (avg. size: | Acrylate | Modified | Index | | Amount | Defects | Hard- | | Haze | ance | |
| Film | 1-100 nm) | Monomer | Acrylate Monomer | Layer | Kind | (%)* | (/m²) | ness | | (%) | (%) | Remark |
| HL-1 | MEK-ST, | PET-30 | Viscoat 360 | yes | none | 0 | 0.8 | 3 | H | 0.30 | 1.3 | invention |
| | MIBK-ST | | | | | | | | | | | |
| HL-2 | MEK-ST, | PET-30 | Viscoat 360 | yes | M-0 | 0.05 | 0.6 | 3 | H | 0.30 | 1.3 | invention |
| | MIBK-ST | | | | | | | | | | | |
| HL-3 | MEK-ST, | PET-30 | Viscoat 360 | yes | M-0 | 0.15 | 0.1 | 3 | H | 0.30 | 1.3 | invention |
| | MIBK-ST | | | | | | | | | | | |
| HL-4 | MEK-ST, | PET-30 | Viscoat 360 | yes | M-0 | 0.50 | 0.01 | 3 | H | 0.30 | 1.3 | invention |
| | MIBK-ST | | | | | | | | | | | |
| HL-5 | MEK-ST, | PET-30 | Viscoat 360 | yes | M-0 | 2.50 | 0.2 | 3 | H | 0.30 | 1.3 | invention |
| | MIBK-ST | | | | | | | | | | | |
| HL-6 | MEK-ST, | PET-30 | Viscoat 360 | yes | M-0 | 3.50 | 0.55 | 2 | H | 0.30 | 1.3 | invention |
| | MIBK-ST | | | | | | | | | | | |
| HL-7 | MEK-ST, | PET-30 | Viscoat 360 | yes | M-1 | 0.50 | 0.02 | 3 | H | 0.30 | 1.3 | invention |
| | MIBK-ST | | | | | | | | | | | |
| HL-8 | MEK-ST, | PET-30 | Viscoat 360 | yes | diethylene | 0.50 | 0.2 | 3 | H | 0.30 | 1.3 | invention |
| | MIBK-ST | | | | glycol | | | | | | | |
| HL-9 | MEK-ST, | PET-30 | Viscoat 360 | yes | isopropyl | 0.50 | 0.6 | 3 | H | 0.30 | 1.3 | invention |
| | MIBK-ST | | | | alcohol | | | | | | | |
| HL-10 | MEK-ST, | PET-30 | Viscoat 360 | yes | 2-hydroxy- | 0.50 | 0.7 | 3 | H | 0.30 | 1.3 | invention |
| | MIBK-ST | | | | ethyl | | | | | | | |
| | | | | | acrylate | | | | | | | |
| HL-11 | MEK-ST, | PET-30 | Viscoat 360 | yes | M-2 | 0.50 | 0.1 | 3 | H | 0.30 | 1.3 | invention |
| | MIBK-ST | | | | | | | | | | | |
| HL-12 | Z7404 | PET-30 | Viscoat 360 | yes | M-0 | 0.50 | 0.01 | 3 | H | 0.30 | 0.8 | invention |
| HL-13 | MEK-ST, | PET-30 | none | yes | none | — | 1.0 | 4 | H | 0.30 | 1.3 | invention |
| | MIBK-ST | | | | | | | | | | | |
| HL-14 | MEK-ST, | PET-30 | none | yes | M-0 | 0.50 | 0.3 | 4 | H | 0.30 | 1.3 | invention |
| | MIBK-ST | | | | | | | | | | | |
| HL-15 | none | PET-30 | Viscoat 360 | yes | M-0 | 0.50 | 0.01 | | H | 0.30 | 1.3 | compari- |
| | | | | | | | | | | | | son |
| HL-16 | MEK-ST, | PET-30 | Viscoat 360 | no | M-0 | 0.50 | 0.01 | 3 | H | 0.30 | 4.0 | invention |
| | MIBK-ST | | | | | | | | | | | |

*The “amount” of the additive is mass % relative to the total solid content.

As is apparent form Table 4, the optical films of the invention have high pencil hardness. It is also seen that coating compositions containing a monomer having at least two hydroxyl groups per molecule (“additive” in Table 4) in a mass fraction of 0.1% to 3.0% relative to the total solid content provide, on being applied and cured, an optical film with reduced point defects, particularly when the monomer has an acryloyl group (M-0, M-1, or M-2), more particularly when the monomer has one acryloyl group per molecule (M-0 or M-1). It is also seen that the coating composition containing an alkylene oxide-modified acrylate monomer provides an optical film with fewer point defects. Furthermore, it is confirmed that optical films having a low refractive index layer have a low reflective index and, when useckas a surfacing film of an image display apparatus, prevents reflection of ambient light and image light, thereby providing excellent display visibility.

1. A coating composition comprising:
(a) inorganic particles having an average particle size of 1 to 100 nm;
(b) an ionizing radiation-curing material for forming a binder;
(c) a photopolymerization initiator; and
(d) an organic solvent.

2. A coating composition comprising:
(a) inorganic particles having an average particle size of 1 to 100 nm;
(b) an ionizing radiation-curing material for forming a binder;
(c) a photopolymerization initiator;
(d) an organic solvent; and
(e) a monomer having at least two hydroxyl groups per molecule in a mass fraction of 0.1 to 3.0 mass % relative to a total solid content of the composition.

3. The coating composition according to claim 2, wherein the monomer (e) has an acryloyl group or a methacryloyl group.

4. The coating composition according to claim 3, wherein the number of the acryloyl group or the methacryloyl group per molecule of the monomer (e) is 1.

5. The coating composition according to claim 2, wherein the ionizing radiation-curing material has an alkylene oxide moiety in a molecule thereof.

6. An optical film comprising a transparent substrate and a layer on the substrate, the layer being formed by coating a coating composition comprising:
(a) inorganic particles having an average particle size of 1 to 100 nm;
(b) an ionizing radiation-curing material for forming a binder;
(c) a photopolymerization initiator;
(d) an organic solvent; and
(e) a monomer having at least two hydroxyl groups per molecule in a mass fraction of 0.1 to 3.0 mass % relative to a total solid content of the composition.

7. The optical film according to claim 6, wherein the layer is a hardcoat layer.

8. The optical film according to claim 7, further comprising, on the layer, a low refractive index layer.

9. A polarizing plate comprising a polarizer and a protective film on both sides of the polarizer, at least one of the protective films is an optical film comprising transparent substrate and a layer on the substrate, the layer being formed by coating a coating composition comprising:
(a) inorganic particles having an average particle size of 1 to 100 nm;
(b) an ionizing radiation-curing material for forming a binder;
(c) a photopolymerization initiator;
(d) an organic solvent; and
(e) a monomer having at least two hydroxyl groups per molecule in a mass fraction of 0.1 to 3.0 mass % relative to a total solid content of the composition.

10. An image display apparatus comprising the an optical film comprising a transparent substrate and a layer on the substrate, the layer being formed by coating a coating composition comprising:
(a) inorganic particles having an average particle size of 1 to 100 nm;
(b) an ionizing radiation-curing material for forming a binder;
(c) a photopolymerization initiator;
(d) an organic solvent; and
(e) a monomer having at least two hydroxyl groups per molecule in a mass fraction of 0.1 to 3.0 mass % relative to a total solid content of the composition.
